(19) United States
(12) Patent Application Publication
(10) Pub. No.: US 2012/0057786 A1
(43) Pub. Date: Mar. 8, 2012

(54) IMAGE PROCESSING APPARATUS, IMAGE PROCESSING METHOD, IMAGE PICKUP APPARATUS, AND STORAGE MEDIUM STORING IMAGE PROCESSING PROGRAM

(75) Inventor: Natsumi Yano, Tokyo (JP)

(73) Assignee: OLYMPUS CORPORATION, Tokyo (JP)

(21) Appl. No.: 13/214,646

(22) Filed: Aug. 22, 2011

(30) Foreign Application Priority Data
Sep. 2, 2010 (JP) 2010-196636

(51) Int. Cl. G06K 9/46

(52) U.S. Cl. 382/170

(57) ABSTRACT

An image processing apparatus determines an importance of subject in an image. The image processing apparatus comprises an image input unit that inputs a series of multiple frames of images captured in temporal sequence, a determination target region extraction unit that extracts determination target regions to be subjected to an importance determination from the images on the multiple frames input into the image input unit, and a determination unit that determines an importance of the determination target regions on the basis of an appearance frequency of the determination target regions in the images on the multiple frames.

### FIELD OF THE INVENTION

This invention relates to a technique for determining an importance of a subject in a series of multiple frames of images generated by an image input device such as a camera or the like.

### DESCRIPTION OF THE RELATED ART

Image processing may be performed on an image photographed by a digital camera, for example, so that the image gives a more favorable impression. In this case, an effective result can be obtained by performing the processing after dividing the image into a region in which a subject (a subject having great importance) determined by a photographer to be a main subject exists and a remaining region. For example, image processing may be performed to increase a saturation of the subject having great importance and reduce the saturation of other subjects so that the subject having great importance stands out, or the like. In addition to this type of image processing, during automatic focus adjustment (AF) control, automatic exposure adjustment (AE) control, and so on in a digital camera, the control can be performed more effectively by inputting information indicating a main subject into AF and AE control units. When control is performed during moving image pickup, for example, so that a position of a subject having great importance on a screen can be detected continuously (followed) and the focus and exposure can be aligned with this position continuously, an improvement is achieved in the user-friendliness of the camera.

Hence, to ensure that image processing and control such as AF and AE control are performed in an image pickup apparatus more effectively, it is important to determine the importance of a subject in a photographed image with improved accuracy.

JP4254873B discloses a technique for detecting a facial image from an input image and determining an importance and an order of precedence of a subject in accordance with the position, movement, and speed of the facial image. In JP4254873B, the importance of the subject is determined in accordance with following references.

(1) The importance increases as a size of a detected face increases.
(2) The importance of a subject on which the detected face moves quickly is lowered.
(3) When a plurality of faces are detected, the importance thereof is increased steadily toward a frame lower side.
(4) When a plurality of faces are detected, in addition to (3), the importance of a detected face positioned closer to a center of gravity of all of the detected faces is increased.

Further, JP2010-9425A discloses a technique for determining the importance of a subject on the basis of the movement of the subject in a case where a plurality of subjects appear on the screen. In the technique disclosed in JP2010-9425A, a movement of an image pickup apparatus that photographs a moving image is extracted together with the movement of a subject appearing on the screen. The importance of the subject is then determined using a difference between these movements (a relative speed). More specifically, the relative speed decreases when the photographer follows the subject while changing the orientation of the image pickup apparatus, and conversely, the relative speed increases when the orientation of the image pickup apparatus is fixed and the subject is not followed. A subject having a low relative speed is set as a main subject.

### SUMMARY OF THE INVENTION

According to the first aspect of the invention, an image processing apparatus determines an importance of a subject in an image, and the image processing apparatus comprises:

an image input unit that inputs a series of multiple frames of images captured in temporal sequence;

a determination target region extraction unit that extracts determination target regions to be subjected to an importance determination from the images on the multiple frames input into the image input unit; and

a determination unit that determines the importance of the determination target regions on the basis of an appearance frequency of the determination target regions in the images on the multiple frames.

According to the second aspect of the invention, an image processing method for determining an importance of a subject in an image is provided, and the method comprises:

an image inputting step for inputting a series of multiple frames of images captured in temporal sequence;

a determination target region extracting step for extracting determination target regions to be subjected to an importance determination from the images on the multiple frames input in the image inputting step; and

a determining step for determining the importance of the determination target regions on the basis of an appearance frequency of the determination target regions in the images on the multiple frames.

According to the third aspect of the invention, an image pickup apparatus comprises an imaging device capable of subjecting an object image formed by an image pickup lens to photoelectric conversion and outputting a corresponding image signal, and the image pickup apparatus comprises:

an image input unit that inputs a series of multiple frames of images captured in temporal sequence;

a determination target region extraction unit that extracts determination target regions to be subjected to an importance determination from the images on the multiple frames input into the image input unit; and

a determination unit that determines an importance of the determination target regions on the basis of an appearance frequency of the determination target regions in the images on the multiple frames.

According to the fourth aspect of the invention, a non-transitory computer-readable storage medium storing an image processing program for causing a computer to execute processing for determining an importance of a subject in an image, and the image processing program comprises:

an image inputting step for inputting a series of multiple frames of images captured in temporal sequence;

a determination target region extracting step for extracting determination target regions to be subjected to an importance determination from the images on the multiple frames input in the image inputting step; and

a determining step for determining the importance of the determination target regions on the basis of an appearance frequency of the determination target regions in the images on the multiple frames.

### BRIEF DESCRIPTION OF THE DRAWINGS

The present invention is described in detail below with reference to the following Figures.

FIG. 1 is a schematic block diagram illustrating an internal constitution of an image processing apparatus.

FIG. 2 is a block diagram illustrating an example in which the image processing apparatus is provided in a digital camera.

FIG. 3 is a block diagram illustrating an example in which the image processing apparatus is realized by a computer that executes an image processing program.

FIG. 4 is a view illustrating an example of a photographed scene photographed by a digital camera according to a first embodiment.

FIG. 5 is a view illustrating a manner in which an input image is analyzed and a plurality of regions (determination target regions) are extracted.

FIG. 6 is a flowchart illustrating processing steps of importance determination processing and a subsequent series of image pickup operations, executed in the digital camera according to the first embodiment.

FIG. 7 is a view showing an example of appearance frequency derivation results obtained for respective determination target regions.

FIG. 8A is a view illustrating a manner in which determination target regions are extracted in a camera according to a second embodiment, and a view showing a single frame of an image input into an image input unit.

FIG. 8B is a view illustrating a manner in which determination target regions are extracted in the camera according to the second embodiment, and a view illustrating a manner in which six determination target regions are extracted.

FIG. 8C is a view illustrating a manner in which determination target regions are extracted in the camera according to the second embodiment, and a view illustrating a manner in which a region in the vicinity of a center of gravity of the respective determination target regions is extracted.

FIG. 9 is a flowchart illustrating processing steps of importance determination processing and a subsequent series of image pickup operations, executed in the digital camera according to the second embodiment.

FIG. 10 is a graph illustrating an example of a characteristic referenced when weighting is performed on the basis of a time difference between a release time and an appearance time of each determination target region during derivation of the appearance frequency of each determination target region.

FIG. 11A is a view illustrating a manner in which a weighting is applied to the appearance frequency of each determination target region on the basis of the weighting characteristic shown in FIG. 10, and a view showing an example of appearance frequencies derived when weighting is not performed.

FIG. 11B is a view illustrating a manner in which a weighting is applied to the appearance frequency of each determination target region on the basis of the weighting characteristic shown in FIG. 10, and a view showing an example of appearance frequencies derived when weighting is performed.

FIG. 12A is a view illustrating a manner in which determination target regions are extracted in a digital camera according to a third embodiment, and a view showing a single frame of an image input into an image input unit.

FIG. 12B is a view illustrating a manner in which determination target regions are extracted in the digital camera according to the third embodiment, and a view illustrating a manner in which three determination target regions are extracted.

FIG. 13 is a flowchart illustrating processing steps of importance determination processing and a subsequent series of image pickup operations, executed in the digital camera according to the third embodiment.

FIG. 14 is a graph illustrating an example of a characteristic referenced when weighting is performed on the basis of a brightness and a saturation in the determination target region during derivation of the appearance frequency of each determination target region.

FIG. 15 is a graph illustrating an example of a characteristic referenced when weighting is performed on the basis of either the brightness or the saturation in the determination target region during derivation of the appearance frequency of each determination target region.

FIG. 16A is a view illustrating a manner in which a weighting is applied to the appearance frequency of each determination target region on the basis of the weighting characteristic shown in FIG. 14 or 15, and a view showing an example of appearance frequencies derived when weighting is not performed.

FIG. 16B is a view illustrating a manner in which a weighting is applied to the appearance frequency of each determination target region on the basis of the weighting characteristic shown in FIG. 14 or 15, and a view showing an example of appearance frequencies derived when weighting is performed.

FIG. 17A is a view illustrating a manner in which determination target regions are extracted in a digital camera according to a fourth embodiment, and a view showing a single frame of an image input into an image input unit.

FIG. 17B is a view illustrating a manner in which determination target regions are extracted in the digital camera according to the fourth embodiment, and a view showing an example of a single frame of an image that is input into the image input unit following the image shown in FIG. 17A as the digital camera is panned.

FIG. 17C is a view illustrating a manner in which determination target regions are extracted in the digital camera according to the fourth embodiment, and a view showing a manner in which motion vectors are derived from two frames of images input in series as the digital camera is panned.

FIG. 17D is a view illustrating a manner in which determination target regions are extracted in the digital camera according to the fourth embodiment, and a view illustrating a manner in which three determination target regions are extracted on the basis of similarities among the motion vectors.

FIG. 18A is a view illustrating a manner in which a number of consecutive appearances of a determination target region is counted, and a view showing an example of a case in which the number of consecutive appearances is counted at 3.

FIG. 18B is a view illustrating a manner in which the number of consecutive appearances of a determination target region is counted, and a view showing an example of a case in which the number of consecutive appearances is counted at 2.

FIG. 19 is a flowchart illustrating processing steps of importance determination processing and a subsequent series of image pickup operations, executed in the digital camera according to the fourth embodiment.

FIG. 20 is a graph showing an example of the number of consecutive appearances counted for each determination target region.

FIG. 21 is a graph illustrating an example of a characteristic referenced when weighting is performed on the basis of the number of consecutive appearances of a determination target region during derivation of the appearance frequency of each determination target region.

FIG. 22A is a view illustrating a manner in which a weighting is applied to the appearance frequency of each determination target region on the basis of the weighting characteristic shown in FIG. 21, and a view showing an example of appearance frequencies derived when weighting is not performed.

FIG. 22B is a view illustrating a manner in which a weighting is applied to the appearance frequency of each determination target region on the basis of the weighting characteristic shown in FIG. 21, and a view showing an example of appearance frequencies derived when weighting is performed.

FIG. 23A is a schematic view showing a method of accumulating motion vectors derived from a plurality of frames of sequentially input images along a temporal axis, and a schematic view showing a motion vector group derived from neighborhood frames.

FIG. 23B is a schematic view showing the method of accumulating motion vectors derived from a plurality of frames of sequentially input images along a temporal axis, and a schematic view showing a manner in which, during motion vector integration along the temporal axis, directions of the motion vectors are ignored and only absolute values are accumulated.

FIG. 23C is a schematic view showing the method of accumulating motion vectors derived from a plurality of frames of sequentially input images along a temporal axis, and a schematic view showing a manner in which, during motion vector accumulation along the temporal axis, the directions and the absolute values of the motion vectors are taken into account.

FIG. 24 is a flowchart illustrating processing steps of importance determination processing and a subsequent series of image pickup operations, executed in a digital camera according to a fifth embodiment.

FIG. 25 is a graph showing an example of a degree of motionlessness derived for each determination target region.

FIG. 26 is a graph illustrating an example of a characteristic referenced when weighting is performed on the basis of the degree of motionlessness of a determination target region during derivation of the appearance frequency of each determination target region.

FIG. 27A is a view illustrating a manner in which a weighting is applied to the appearance frequency of each determination target region on the basis of the weighting characteristic shown in FIG. 26, and showing an example of appearance frequencies derived when weighting is not performed.

FIG. 27B is a view illustrating a manner in which a weighting is applied to the appearance frequency of each determination target region on the basis of the weighting characteristic shown in FIG. 26, and a view showing an example of appearance frequencies derived when weighting is performed.

### DETAILED DESCRIPTION OF THE PREFERRED EMBODIMENTS

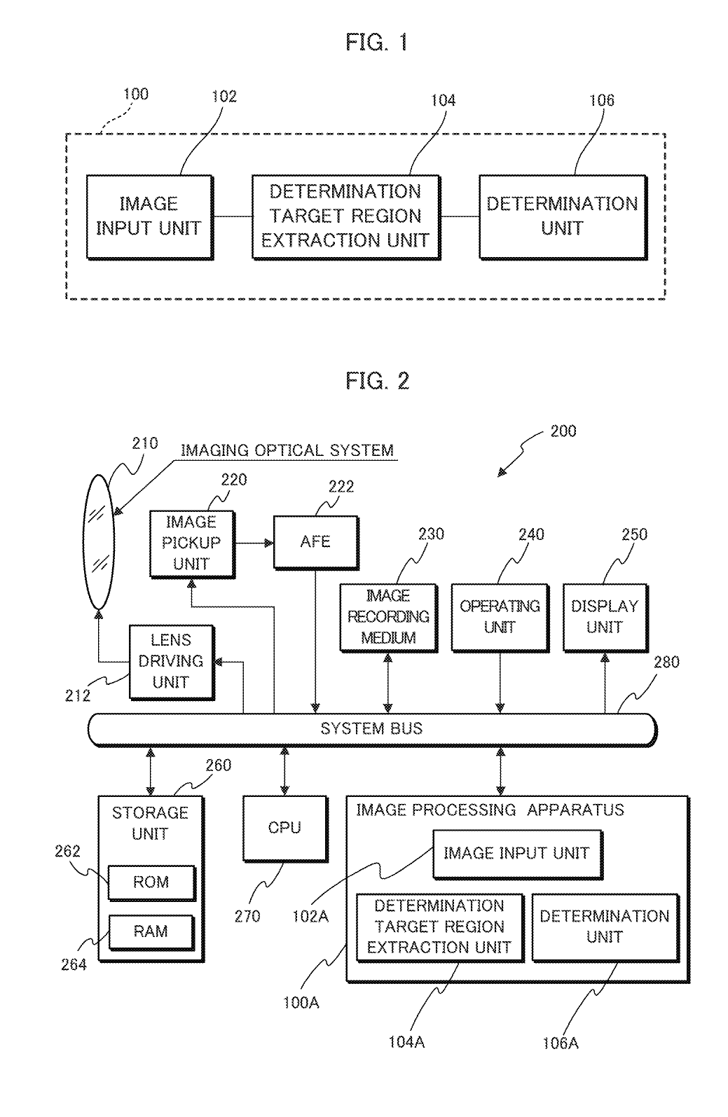

FIG. 1 is a schematic block diagram illustrating the constitution of an image processing apparatus 100 according to an embodiment of this invention. The image processing apparatus 100 includes an image input unit 102, a determination target region extraction unit 104, and a determination unit 106.

The image input unit 102 inputs a series of multiple frames of images captured in temporal sequence. The determination target region extraction unit 104 extracts determination target regions to be subjected to an importance determination from the plurality of frames of the images input into the image input unit 102. The determination unit 106 determines the importance of the determination target regions on the basis of an appearance frequency of each determination target region extracted by the determination target region extraction unit 104. Processing performed by the image input unit 102, determination target region extraction unit 104, and determination unit 106 will be described in detail below.

The image processing apparatus 100 may be provided in an image input apparatus such as a digital still camera or a digital movie camera. Alternatively, functions of the image processing apparatus 100 may be realized by an image processing program recorded on a recording medium and a computer that executes the image processing program.

FIG. 2 is a block diagram showing an example in which an image processing apparatus 100A is packaged in a digital camera 200 such as a digital still camera or a digital movie camera. The digital camera 200 includes an imaging optical system 210, a lens driving unit 212, an image pickup unit 220, an analog front end (indicated by “AFE” in FIG. 2) 222, an image recording medium 230, an operating unit 240, a display unit 250, a storage unit 260, a CPU 270, the image processing apparatus 100A, and a system bus 280. The storage unit 260 includes a ROM 262 and a RAM 264.

The lens driving unit 212, image pickup unit 220, analog front end 222, image recording medium 230, operating unit 240, display unit 250, storage unit 260, CPU 270, and image processing apparatus 100A are electrically connected via the system bus 280. The RAM 264 can be accessed from both the CPU 270 and the image processing apparatus 100A.

The imaging optical system 210 forms an object image on a light receiving area of the image pickup unit 220. The lens driving unit 212 performs a focus adjustment operation on the imaging optical system 210. Further, when the imaging optical system 210 is an optical system having a variable focal length, the imaging optical system 210 may be driven by the lens driving unit 212 to modify the focal length.

The image pickup unit 220 generates an analog image signal by subjecting the object image formed on the light receiving area to photoelectric conversion. The analog image signal is input into the analog front end 222. The analog front end 222 performs processing such as noise reduction, amplification, and A/D conversion on the image signal input from the image pickup unit 220 to generate a digital image signal. The digital image signal is stored temporarily in the RAM 264.

The image processing apparatus 100A implements various types of digital signal processing, such as demosaicing, tone conversion, color balance correction, shading correction, and noise reduction, on the digital image signal stored temporarily in the RAM 264, and if necessary records the digital image signal on the image recording medium 230 and outputs the signal to the display unit 250.

The image recording medium 230 is constituted by a flash memory, a magnetic recording device, or the like that can be attached to the digital camera 200 detachably. It should be noted that the image recording medium 230 may be built into the digital camera 200. In such a case, an area for recording image data can be reserved in the ROM 262.

The operating unit 240 includes one or a plurality of push switches, slide switches, dial switches, touch panels, and so on in order to accept operations from a user. The display unit 250 includes a TFT liquid crystal display panel and a backlight device, or a light-emitting display device such as an organic EL display device, and is capable of displaying information in the form of images, alphabetic characters, and so on. The display unit 250 also includes a display interface processing unit so that image data written to a VRAM area reserved on the RAM 264 can be read by the display interface processing unit and displayed on the display unit 250 in form of images, alphabetic characters, and so on.

The ROM 262 is constituted by a flash memory or the like, and stores control programs (firmware) executed by the CPU 270, adjustment parameters, information that needs to be held even when a power supply of the digital camera 200 is OFF, and so on. The RAM 264 is constituted by an SDRAM or the like, and has a comparative high access speed. The CPU 270 performs overall control of operations of the digital camera 200 by interpreting and executing firmware transferred to the RAM 264 from the ROM 262.

The image processing apparatus 100A is constituted by a DSP (digital signal processor) or the like, and performs the various types of processing described above on the digital image signal stored temporarily in the RAM 264 to generate recording image data, display image data, and so on. Further, the image processing apparatus 100A includes an image input unit 102A, a determination target region extraction unit 104A, and a determination unit 106A, and performs processing to be described below.

It is assumed as a precondition that the digital camera 200 is set in an operating mode for photographing still images, and is in an image pickup preparation operating condition prior to the start of a release operation so as to be capable of accepting a release operation performed by the user. Further, it is assumed that in the image pickup preparation operating condition, an image pickup operation is performed repeatedly by the image pickup unit 220 at a predetermined frame rate of 30 fps (frames/second), for example, whereby live view display image data are generated by the image processing apparatus 100A and a live view image is displayed on the display unit 250. At this time, the image input unit 102A successively inputs a series of multiple frames of images captured in temporal sequence. When the image pickup operation for live view display is performed at 30 fps, as described above, the image input unit 102A may input the images of all of the frames or input the image of a single frame for every predetermined plurality of frames.

The determination target region extraction unit 104A extracts determination target regions to be subjected to an importance determination from the plurality of frames of the respective images input into the image input unit 102A. The determination target region extraction unit 104A records information enabling specification of each extracted determination target region and information relating to an appearance frequency of each determination target region. When a release operation by the user is detected, the determination unit 106A determines the importance of the determination target regions extracted by the determination target region extraction unit 104A on the basis of the extracted determination target regions and the appearance frequencies thereof.

Determination target region extraction and recording of the appearance frequencies of the determination target regions may be executed by the determination target region extraction unit 104A continuously from the start of the image pickup preparation operation, i.e. when the power supply of the digital camera 200 is switched ON and the operating mode thereof is switched to an image pickup mode, until the release operation by the user is detected. Alternatively, determination target region extraction and recording of the appearance frequencies of the determination target regions may be executed continuously from the start of the image pickup preparation operation such that most recent extraction results and counting results are recorded at all times, while older extraction results and counting results are discarded successively such that only the extraction results and counting results obtained during a most recent predetermined time are held at all times. With respect to this point, it is assumed in the following description that a period of 60 seconds, for example, elapses between the start of the image pickup preparation operation and the release operation. All of the extraction results and counting results obtained over the 60 seconds may be recorded for reference. Alternatively, old information, for example extraction results and counting results obtained 30 seconds or more before the release operation, may be discarded such that the importance is always determined by referring to the extraction results and counting results obtained during the last 30 seconds.

Processing such as focus adjustment, exposure adjustment, and color correction is performed in the digital camera 200, referring to the importance determination results obtained in the process implemented by the determination unit 106A. In other words, the focus adjustment, exposure adjustment, color correction processing, and so on can be performed with a priority on a position within the image where the main subject appears.

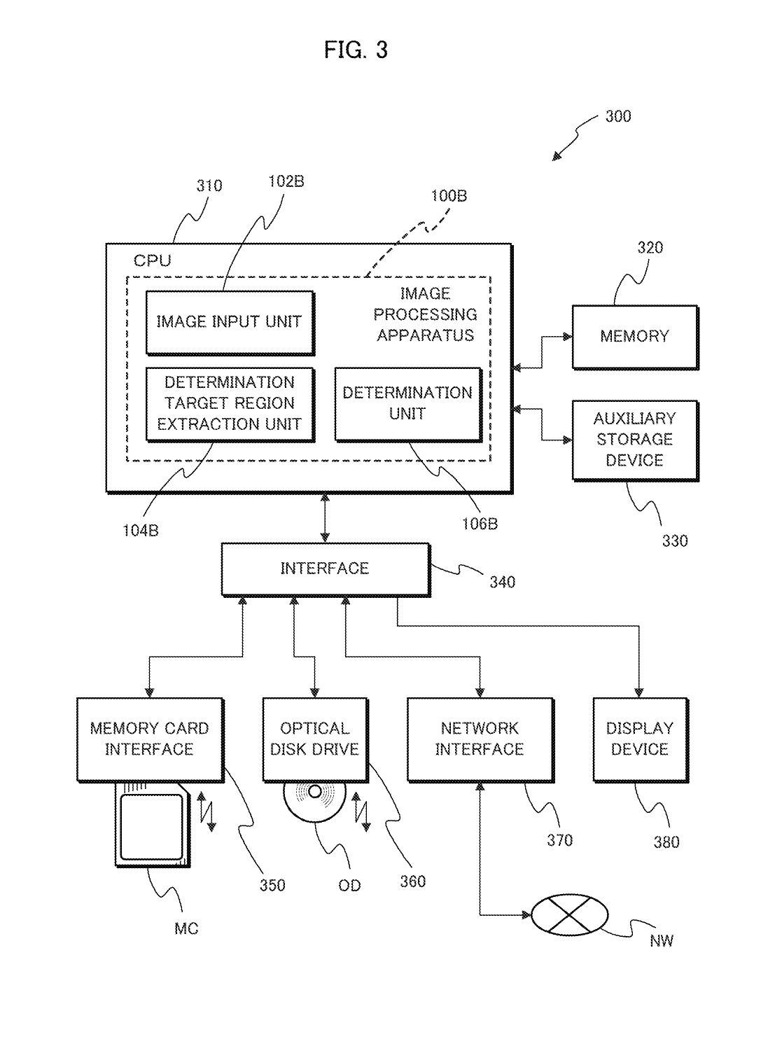

FIG. 3 is a block diagram illustrating an example in which functions of an image processing apparatus are realized by having a CPU of a computer read and execute an image processing program recorded on a recording medium. A computer 300 includes a CPU 310, a memory 320, an auxiliary storage device 330, an interface 340, a memory card interface 350, an optical disk drive 360, a network interface 370, and a display device 380. The CPU 310, the memory card interface 350, the optical disk drive 360, the network interface 370, and the display device 380 are electrically connected via the interface 340.

The memory 320 is a memory having a comparatively high access speed, such as a DDR SDRAM. The auxiliary storage device 330 is constituted by a hard disk drive, a solid state drive (SSD), or the like, and has a comparatively large storage capacity.

The memory card interface 350 is constituted so that a memory card MC can be attached thereto detachably. Image data generated during an image pickup operation by a digital camera or the like and stored on the memory card MC can be read to the computer 300 via the memory card interface 350. Further, image data in the computer 300 can be written to the memory card MC.

The optical disk drive 360 is constituted to be capable of reading data from an optical disk OD. The optical disk drive 360 is also constituted to be capable of writing data to the optical disk OD if necessary.

The network interface 370 is constituted to be capable of transmitting information between the computer 300 and an external information processing apparatus such as a server that is connected via a network NW.

The image processing apparatus 100B is realized by having the CPU 310 interpret and execute an image processing program loaded onto the memory 320. The image processing program is recorded on a non-transitory computer-readable medium such as the memory card MC or the optical disk OD and distributed to a user of the computer 300. Alternatively, the image processing program may be downloaded from the server or other external information processing apparatus via the network NW and stored in the auxiliary storage device 330 or the like.

The image processing apparatus 100B includes an image input unit 102B, a determination target region extraction unit 104B, and a determination unit 106B, and performs processing to be described below.

It is assumed as a precondition that a program for processing moving image data is running on the computer 300, and that processing is underway for successively reading moving image data read from the optical disk OD or the like and stored in the auxiliary storage device 330 and determining the main subject appearing in the moving image.

The image input unit 102B successively reads and inputs a series of multiple frames of images captured in temporal sequence from the auxiliary storage device 330. At this time, the image input unit 102B may input images of all of the frames read from the auxiliary storage device 330 or input the image of a single frame for every predetermined plurality of frames.

The determination target region extraction unit 104B extracts determination target regions to be subjected to the importance determination from the plurality of frames of the respective images input into the image input unit 102B. The determination unit 106B determines the importance of the determination target regions extracted by the determination target region extraction unit 104B on the basis of the appearance frequencies of the extracted determination target regions.

The processing of the determination target region extraction unit 104B described above may be performed while reading moving image data included in a single moving image file from top to tail, or performed on a part of the moving image data such as a head part, an intermediate part, or a tail part.

When the processing of the image input unit 102B, determination target region extraction unit 104B, and determination unit 106B is complete, the image processing apparatus 100B performs processing to attach information relating to the main subject appearing in the image to a moving image file including the moving image data subjected to the processing described above. By performing this processing, information relating to the main subject appearing in the image can be attached to the moving image file as metadata such as tag information.

For example, by displaying a minified image or the like of the main subject appearing in the image and grouping moving image files in which similar subjects appear on the basis of the metadata attached to the moving image file when a list of moving image files is displayed on the display device 380, the user can find out a target moving image file easily.

Several embodiments will be described below, using as an example a case in which the image processing apparatus 100A is provided in the digital camera 200, as shown in FIG. 2. It is assumed in the following description that the power supply of the digital camera 200 is ON and the digital camera 200 is set in the image pickup mode. It is also assumed that the image pickup operation for displaying a live view image on the display unit 250 has been performed repeatedly by the image pickup unit 220 so that a release operation by the user can be accepted. Processing to be described in detail below in the respective embodiments is then performed in the image input unit 102A, the determination target region extraction unit 104A, and the determination unit 106A, whereby the importance of determination target regions appearing on an image is determined successively. Then, when the release operation by the user is detected, processing such as focus adjustment, exposure adjustment, and color correction is performed on the basis of the determination results obtained by the determination unit 106A in relation to the importance of the determination target regions. In other words, the focus adjustment, exposure adjustment, color correction processing, and so on are performed with a priority on the position of the main subject in the image.

### First Embodiment

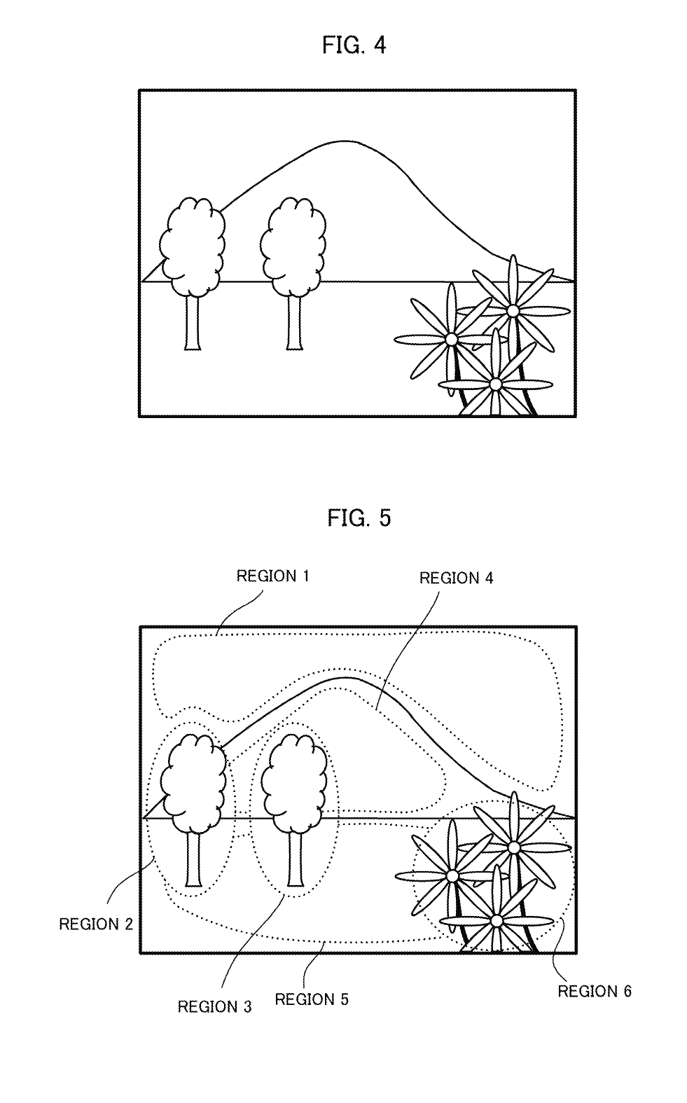

FIG. 4 is a view showing an example of an image generated by image pickup in the image pickup unit 220 of the digital camera 200 and input into the image input unit 102A. The determination target region extraction unit 104A analyzes a color and a position of each pixel in the input image, and extracts determination target regions, or in other words regions for which the importance is to be determined, on the basis of similarities between the colors and positions of the pixels.

FIG. 5 shows determination target regions (region 1, region 2, . . . , region 6) extracted by the determination target region extraction unit 104A. The determination target region extraction unit 104A performs the processing for extracting the determination target regions repeatedly, but a processing load may be lightened by determining a region including a center of gravity position or a representative region (a region in which an eye or the like appears when the determination target region is a face) in each of the initially extracted determination target regions and thereafter performing processing to extract an identical or similar region to the representative regions of the initially extracted determination target regions.

Further, the determination target region extraction processing performed by the determination target region extraction unit 104A may be performed on the frames of all of the images generated through successive image pickup by the image pickup unit 220, or on images obtained by performing skip readout at fixed or unfixed time intervals.

Incidentally, when a photography subject moves bouncily or the determination target region is positioned at an edge of a screen, the determination target region corresponding to the bouncily moving photography subject or the determination target region positioned at the edge of the picture may partially move off picture. In this case, a determination criterion (a threshold) may be determined in advance so that the determination target region extraction unit 104A determines that the partially missing determination target region “appears” when a surface area of the part that remains on screen is equal to or greater than a predetermined % of the original surface area.

The determination unit 106A determines the importance on the basis of the determination target regions extracted by the determination target region extraction unit 104A and an appearance frequency derived in relation to each determination target region. The importance determination processing performed by the determination unit 106A may take various forms depending on the goal. For example, processing may be performed to determine the determination target region having the greatest importance from among the determination target regions extracted by the determination target region extraction unit 104A, or processing may be performed to determine an order of importance of all of the determination target regions. Alternatively, processing may be performed to extract a plurality of determination target regions, for example the top three, five, or ten regions or the like, from all of the determination target regions. Processing may also be performed to order the plurality of extracted determination target regions positioned in the top positions.

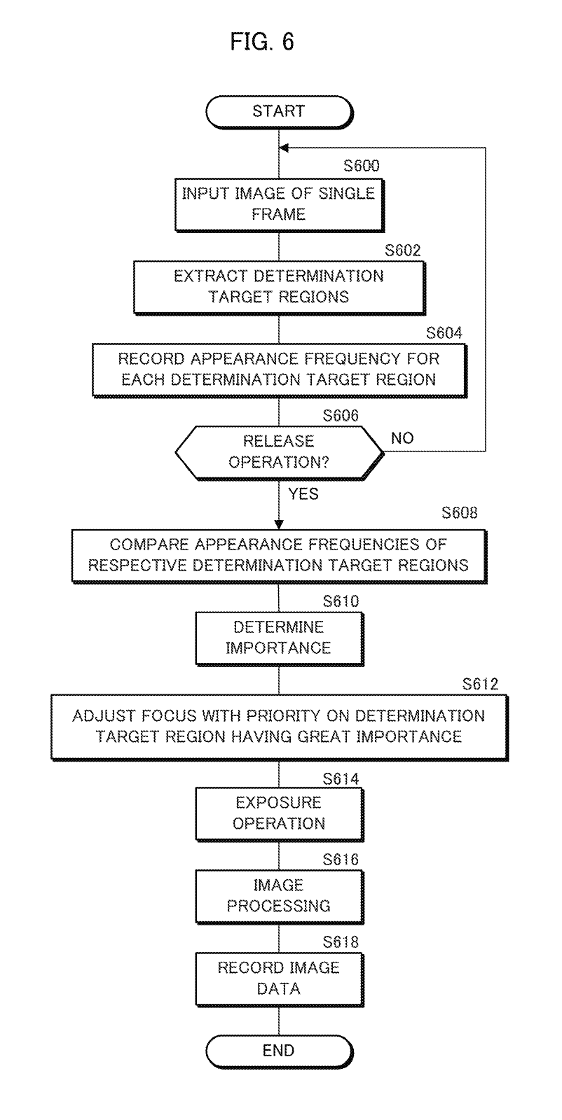

FIG. 6 is a flowchart illustrating an image pickup operation process executed by the CPU 270 of the digital camera 200 and the image processing apparatus 100A. The process shown in FIG. 6 begins when the power supply of the digital camera 200 is switched ON and the operating mode thereof is set in the image pickup mode.

In S600, the image input unit 102A performs processing for inputting an image of a single frame. In S602, the determination target region extraction unit 104A performs processing for extracting the determination target regions. In S604, the determination target region extraction unit 104A performs processing for deriving the appearance frequency of each determination target region and recording information corresponding to the appearance frequency together with information enabling specification of the determination target regions. In S606, the CPU 270 determines whether or not a release operation has been performed, and while the determination is negative, or in other words until the user performs a release operation, the processing from S600 to S606 is performed repeatedly. Meanwhile, a live view image is displayed on the display unit 250, and the user adjusts the composition while viewing the live view image. As described above, the processing for inputting an image of a single frame in S600 for the purpose of live view image display may be performed on all of the image data generated at a frame rate of 30 fps, 60 fps, or the like, or on image data obtained by performing skip readout at fixed or unfixed time intervals.

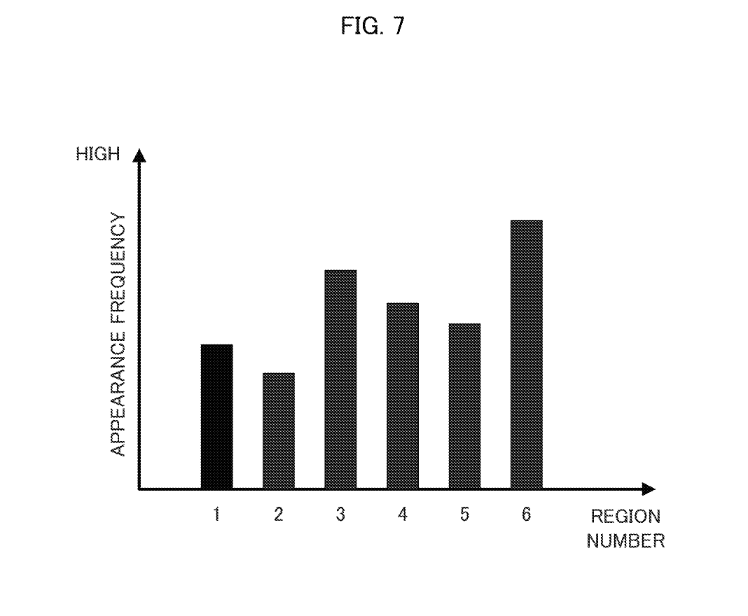

When the determination of S606 is affirmative, or in other words when a release operation performed by the user is detected, the processing advances to S608, where the determination unit 106A performs processing to compare the appearance frequencies of the respective determination target regions. FIG. 7 is a graph showing an example of the appearance frequencies of the respective determination target regions at a point where the processing of S608 is performed. In the example shown in FIG. 7, six determination target regions are extracted while repeatedly performing the processing of S600 to S606, and the determination target region having the highest appearance frequency is a region having a region number 6, followed by a region having the region number 3, followed by a region having the region number 4.

On the basis of the comparison results obtained in S608 in relation to the appearance frequencies of the respective determination target regions, processing to determine the importance of the determination target regions is performed in S610. More specifically, with reference to FIG. 5, it is determined from the results of the processing for comparing the appearance frequencies of the respective determination target regions in S608 that flowers (region 6) positioned on a right side of the screen having the greatest importance. In the importance determination performed in S610, the determination target region having the greatest importance may be extracted, as described above, or a plurality of determination target regions positioned in top rankings may be extracted. Alternatively, information relating to all of the determination target regions or the plurality of determination target regions positioned in the top rankings and information relating to the order thereof may be generated.

In S612, focus adjustment is performed to focus on the determination target region determined to have great importance in S610. In S614, an exposure operation is performed. An exposure amount set during the exposure operation is likewise preferably determined with priority on an object brightness of the determination target region determined to have great importance in S610.

In S616, an image signal obtained from the exposure operation in S614 is processed to generate image data. At this time, a hue, a contrast, and so on are preferably adjusted to produce a more favorable image in the part corresponding to the determination target region determined to have great importance in S610.

In S618, the image data generated in the processing of S616 are recorded on the image recording medium 230. At this time, information relating to the determination target region determined to have great importance may be attached to the image data as tag information.

According to the first embodiment, as described above, determination target regions are extracted respectively from a series of multiple frames of images input during the image pickup preparation operation, and the appearance frequency of each determination target region is derived. Then, in accordance with the release operation, the importance of each determination target region is determined on the basis of the appearance frequency of each determination target region. Focus adjustment is then performed with priority on the determination target region determined to have great importance, and as a result, the user can easily obtain an image that reflects the intended composition without performing a complicated operation.

### Second Embodiment

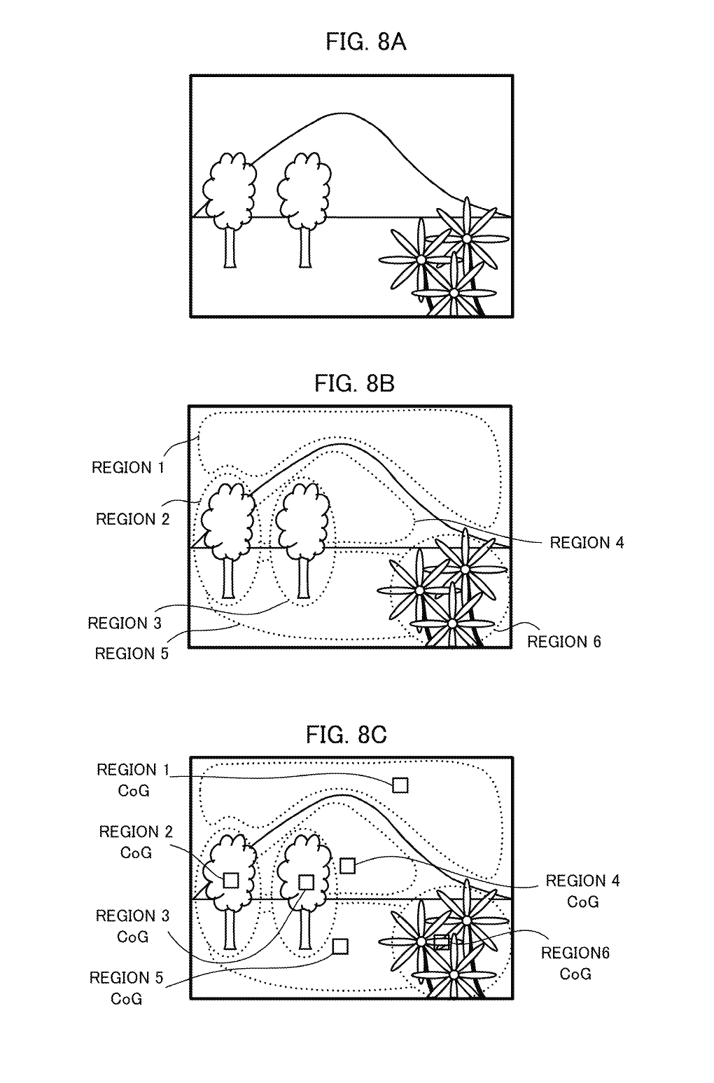

FIG. 8A is a view showing an example of an image generated by image pickup in the image pickup unit 220 of the digital camera 200 shown in FIG. 2 and input into the image input unit 102A. The determination target region extraction unit 104A analyzes the color and position of each pixel in the input image, and extracts determination target regions on the basis of similarities between the colors and positions of the pixels.

FIG. 8B shows the determination target regions (region 1, region 2, . . . , region 6) extracted by the determination target region extraction unit 104A. Further, squares in FIG. 8C indicate regions near the center of gravity of the respective determination target regions extracted by the determination target region extraction unit 104A. In FIG. 8C, center of gravity is indicated by “CoG.” In the second embodiment, when an extracted determination target region appears for the first time (when a determination target region is extracted for the first time during repeated determination target region extraction), the determination target region extraction unit 104A extracts a pattern in the region near the center of gravity of the determination target region. Then, as the processing for extracting determination target regions from the series of multiple frames of the images input into the image input unit 102A is performed repeatedly, processing is performed to extract a similar or identical region to the region near the center of gravity of each determination target region. By performing this processing, the processing load can be lightened. Needless to say, however, the entire extracted determination target region may be set as a reference pattern such that similar patterns are extracted from subsequently input images, similarly to the first embodiment.

Similarly to the first embodiment, the determination target region extraction processing performed by the determination target region extraction unit 104A may be performed on the frames of all of the images generated successively in the image pickup operations performed by the image pickup unit 220 or on images obtained by performing skip readout at fixed or unfixed time intervals.

In the second embodiment, the determination target region extraction unit 104A records each appearance time of the repeatedly extracted determination target regions before the release operation is performed in the digital camera 200. More specifically, the existence of a determination target region is determined in each of the series of multiple images input in temporal sequence, and when it is determined that the determination target region exists, information enabling specification of the respective determination target regions is recorded together with information enabling specification of the appearance time of the determination target region.

When the release operation is detected subsequently, the determination unit 106A determines a time difference between the recorded appearance times of the respective determination target regions extracted by the determination target region extraction unit 104A and a detection time of the release operation (to be referred to hereafter as a release time). The appearance frequencies of the respective determination target regions are then derived by applying a steadily higher weighting as the time difference decreases (as the appearance time of the determination target region moves closer to the present), after which the importance of the respective determination target regions is determined.

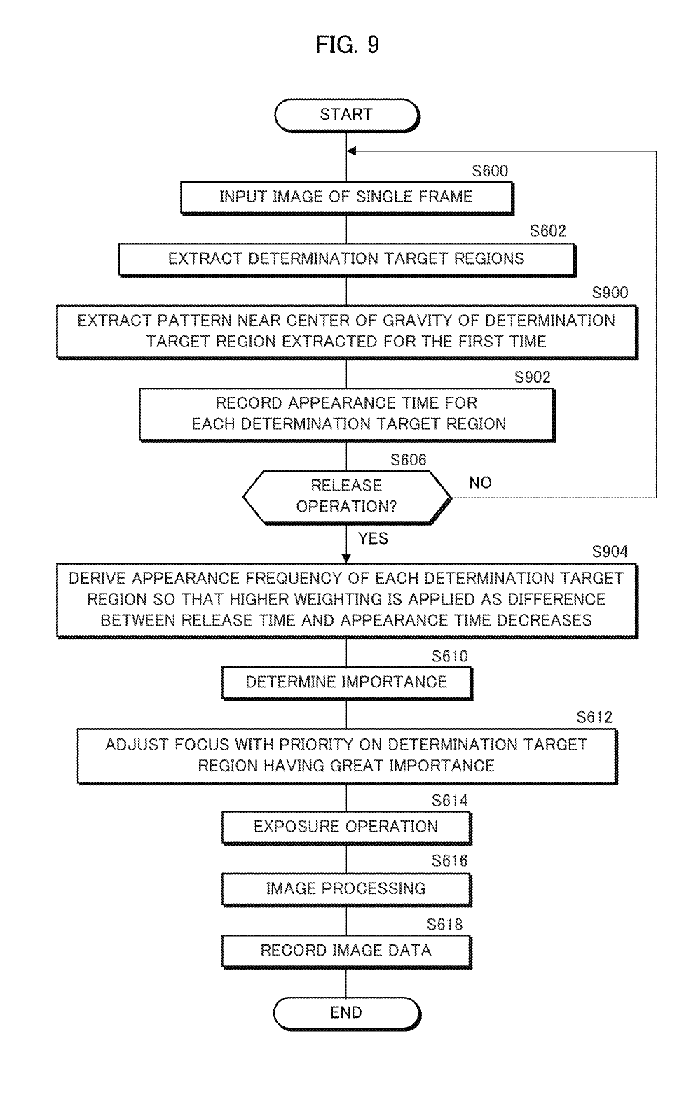

FIG. 9 is a flowchart illustrating an image pickup operation process executed by the CPU 270 of the digital camera 200 and the image processing apparatus 100A. The process shown in FIG. 9 begins when the power supply of the digital camera 200 is switched ON and the operating mode thereof is set in the image pickup mode. In the flowchart of FIG. 9, processing steps having identical content to the processing of the first embodiment, shown in the flowchart of FIG. 6, have been allocated identical step numbers to those of the flowchart in FIG. 6, and for the purpose of simplification, the following description focuses on differences with the first embodiment.

The flowchart of FIG. 9 differs from the first embodiment in that in the flowchart of FIG. 9, the processing (processing for recording the appearance frequency of each determination target region) of S604 in the flowchart of FIG. 6 has been replaced by processing of S900 and 5902, and the processing of S608 in the flowchart of FIG. 6 has been replaced by processing of S904.

During the image pickup preparation operation, the determination target regions are extracted in S602. When a determination target region is extracted for the first time, the pattern near the center of gravity of the determination target region is extracted in S900. In S902, information enabling specification of the determination target region whose appearance has been detected is recorded together with information enabling specification of the appearance time of the determination target region. By performing the processing of S600, S602, S900, S902 and S606 repeatedly during the image pickup preparation operation, an appearance history of the determination target regions (timings at which the respective determination target regions appear) is recorded.

When the release operation by the user is detected subsequently in S606, the processing of S904 is performed. In S904, the determination unit 106A refers to the appearance history of the determination target regions to derive a difference (a time difference) between the release time and the appearance times of the respective determination target regions. Then, when deriving the appearance frequencies of the respective determination target regions, a steadily higher weighting is applied as the difference between the release time and the appearance time decreases.

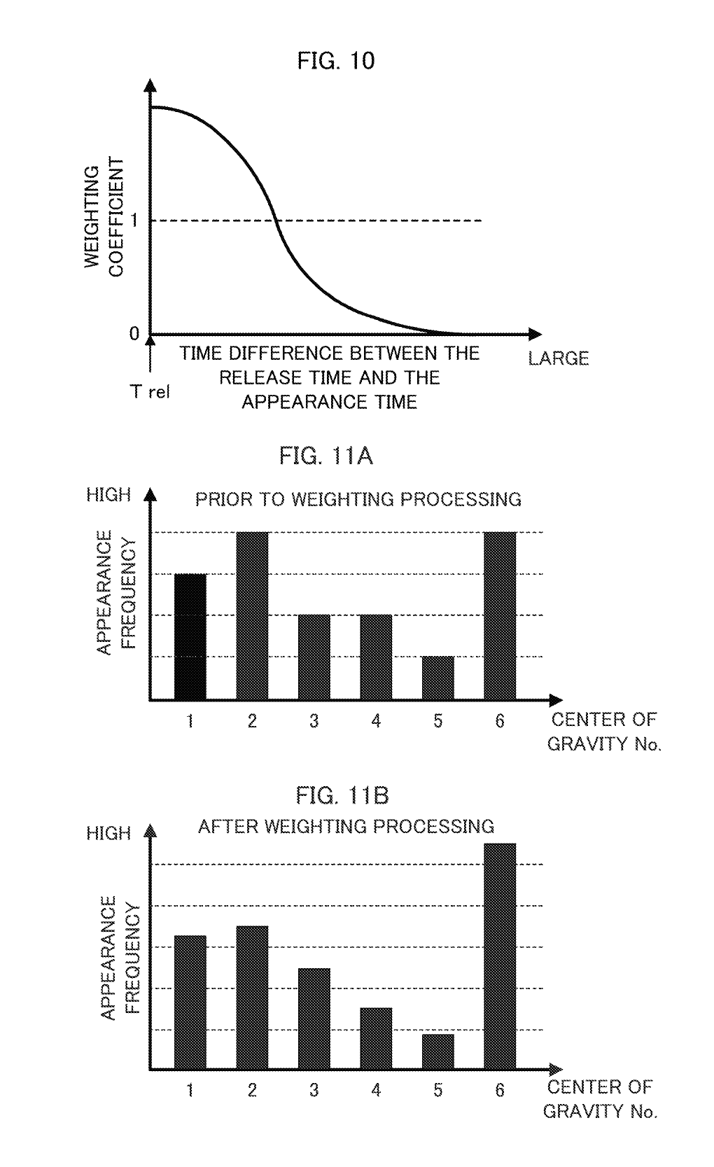

FIG. 10 is a graph showing an example of a characteristic referenced when weighting is performed in the manner described above. In the example shown in FIG. 10, a value close to 2 is applied as a weighting coefficient when the appearance time of the determination target region and the release time substantially match. The weighting coefficient then shifts toward zero as the appearance time of the determination target region moves away from the release time. This weighting characteristic may be defined in advance as a function having the difference between the release time and the appearance time of the determination target region as a variable. Alternatively, the characteristic shown in FIG. 10 may be set on a lookup table and stored in advance in the ROM 262.

FIG. 11 is a view showing an example of the manner in which the appearance frequency of the region near the center of gravity of each determination target region is derived when the determination unit 106A performs the weighting processing of S904. In the graph shown in FIG. 11, the abscissa shows a center of gravity number (which is equal to the region number of the determination target region), and the ordinate shows the appearance frequency. FIG. 11A shows an example in which the appearance frequencies are derived without performing the weighting processing described above, while FIG. 11B shows an example in which the appearance frequencies are derived after performing the weighting processing described above.

In the example shown in FIG. 11, the time difference between the appearance time of the determination target region corresponding to the center of gravity number 2 and the release time is comparatively large. In other words, it is assumed that the determination target region corresponding to the center of gravity number 2 has a tendency to appear at a time in the comparatively distant past. For this reason, the appearance frequency of the determination target region corresponding to the center of gravity number 2 is derived such that the appearance frequency following the weighting processing, shown in FIG. 11B, is lower than the appearance frequency prior to the weighting processing, shown in FIG. 11A. Further, the time difference between the appearance time of the determination target region corresponding to the center of gravity number 6 and the release time is comparatively small. In other words, it is assumed that the determination target region corresponding to the center of gravity number 6 has a tendency to appear at a time in the comparatively recent past. For this reason, the appearance frequency of the determination target region corresponding to the center of gravity number 6 is derived such that the appearance frequency following the weighting processing, shown in FIG. 11B, is higher than the appearance frequency prior to the weighting processing, shown in FIG. 11A.

Following the processing of S904, the determination unit 106A performs the importance determination processing in S610. The processing of S612, S614, S616 and S618 is then performed on the basis of the importance determination results obtained in S610.

According to the second embodiment, as described above, determination target regions are extracted from the series of multiple frames of the respective images input during the image pickup preparation operation, and when an extracted determination target region is extracted for the first time, the pattern near the center of gravity of the determination target region is extracted. Thereafter, processing is performed to extract regions similar to the pattern near the center of gravity, and as a result, the processing load of the image processing apparatus 100A can be lightened.

Further, when the (regions near the center of gravity of the) determination target regions are extracted from the series of multiple frames of the respective images input during the image pickup preparation operation, the information enabling specification of the regions is recorded together with information enabling specification of the appearance timing thereof. Then, when the release operation by the user is detected, the appearance frequency of each determination target region is derived while applying a steadily higher weighting as the difference between the release time and the appearance time decreases. The importance is then determined.

Hence, the importance can be determined with priority on a determination target region having a comparatively recent appearance history (that has a tendency to appear in the comparatively recent past). For example, the user adjusts the orientation and the focal length of the digital camera 200 while viewing the live view image in order to find a target subject during the image pickup preparation operation, and during this process, determination target region extraction is performed continuously. After finding the target subject, the user points the digital camera 200 toward the target subject continuously so that the subject is accommodated within the picture. Eventually, a photo opportunity arises and the user performs the release operation. In this case, with the second embodiment, the importance of the subject can be determined more accurately, and therefore an image reflecting the intended composition of the user can be obtained.

### Third Embodiment

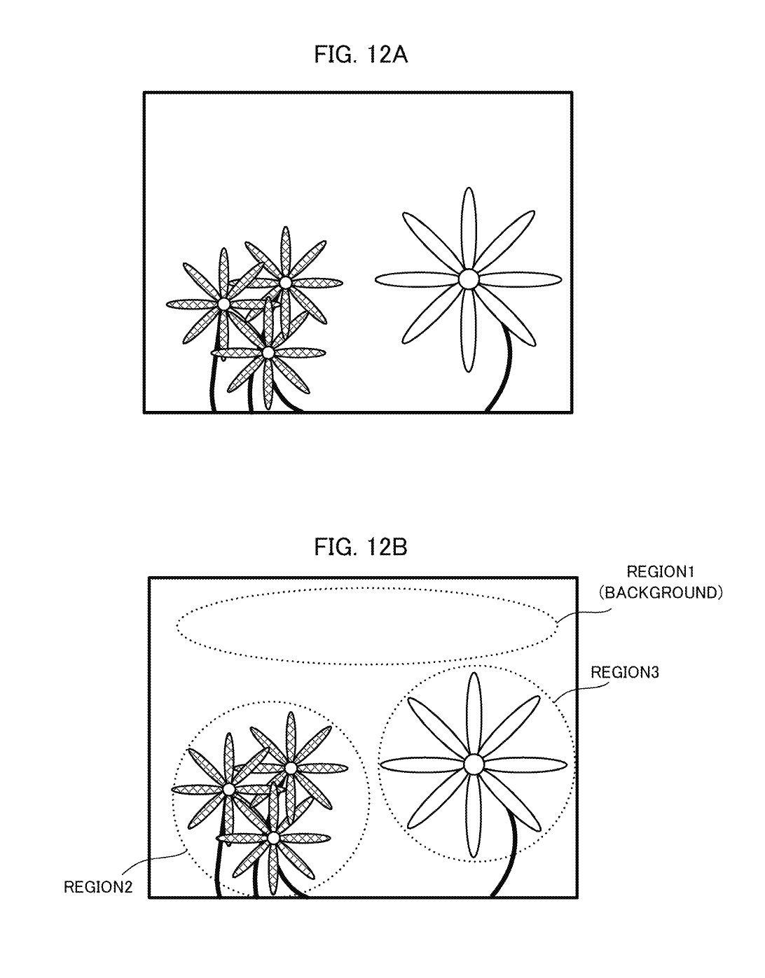

In a third embodiment, an example that is particularly effective when the digital camera 200 is set in a specific image pickup mode, for example a macro mode or the like, will be described. FIG. 12 is a view showing an example of an image generated by image pickup in the image pickup unit 220 of the digital camera 200 and input into the image input unit 102A. The determination target region extraction unit 104A analyzes the color and position of each pixel in the input image shown in the example of FIG. 12A, and extracts determination target regions on the basis of similarities of the colors and positions of the pixels. FIG. 12B shows an example of the determination target regions (region 1, region 2, region 3) extracted by the determination target region extraction unit 104A. It is assumed in FIG. 12 that flowers appearing in the region 3 have a higher brightness and a higher saturation than flowers appearing in the region 2, and that a background appears in the region 1.

In the third embodiment, the determination target region extraction unit 104A records information relating to the brightness and the saturation of the determination target regions every time the determination target regions are extracted up to the release operation performed in the digital camera 200. More specifically, the existence of a determination target region is determined in the series of multiple frames of the respective images input in temporal sequence, and when it is determined that the determination target region exists, information enabling specification of the respective determination target regions is recorded together with information enabling specification of the brightness and saturation of the determination target region and information enabling specification of the appearance time of the determination target region.

At this time, the determination target region extraction unit 104A also records information indicating region properties of the respective determination target regions. The region property information includes an estimation result of a type of subject existing in the determination target region. For example, information enabling specification of types such as “background”, “flower”, and “face” may be included in the region property information. In this embodiment, the determination target region extraction unit 104A estimates whether or not the determination target region is a background, and when the determination target region is likely to be a background, this is recorded in the region property information. When estimating whether or not a determination target region is a background, a color, a brightness, a spatial frequency, a size, and so on of the determination target region may be taken into consideration. In the example shown in FIG. 12B, it is determined that the region 1 is a background.

The determination target region extraction unit 104A may employ either of the methods described in the first and second embodiments to extract determination target regions repeatedly from the series of multiple frames of the images input into the image input unit 102A. Further, the determination target region extraction processing may be performed on the frames of all of the images generated through successive image pickup by the image pickup unit 220 or on images obtained by performing skip readout at fixed or unfixed time intervals.

To determine the importance of each determination target region, the determination unit 106A derives the appearance frequency so that when determination target regions have identical appearance frequencies, the appearance frequency derived from appearances of the determination target region having the higher brightness and saturation is set to be higher. Further, the determination target region having a high derived appearance frequency is determined to have great importance.

The determination unit 106A is also constituted to be capable of performing processing for specifying the determination target region corresponding to the part on which the background appears from the determination target regions extracted by the determination target region extraction unit 104A on the basis of the region property information, and excluding this region from the importance determination targets.

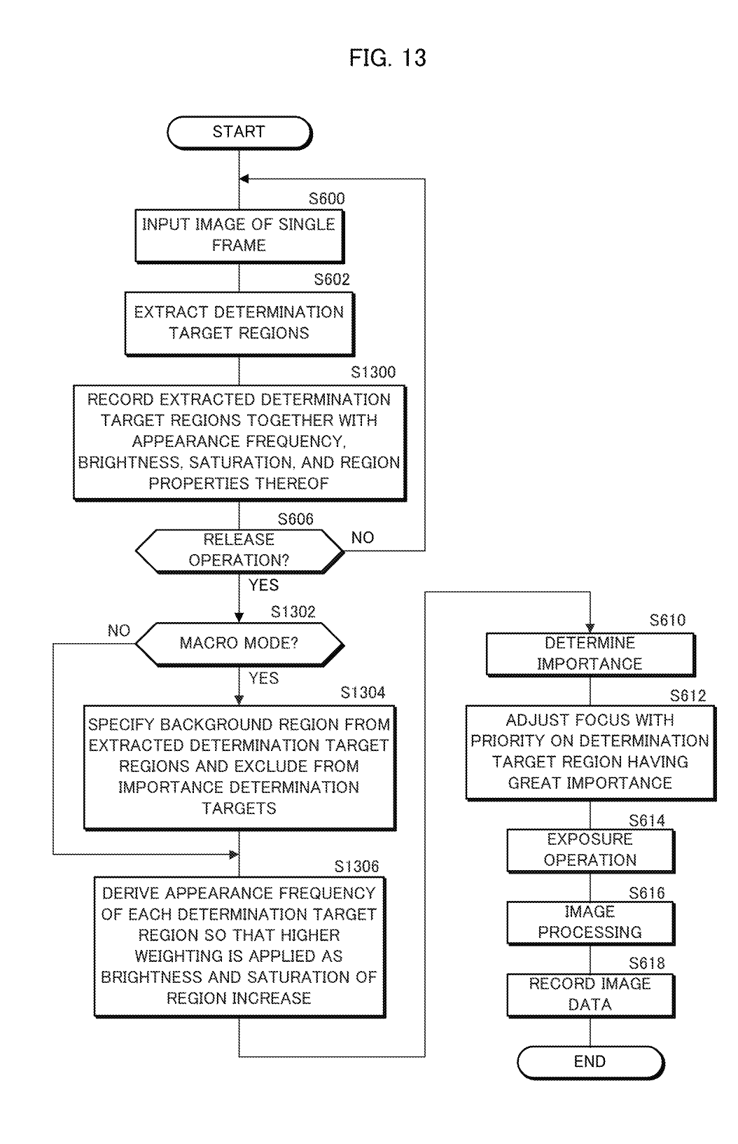

FIG. 13 is a flowchart illustrating an image pickup operation process executed by the CPU 270 of the digital camera 200 and the image processing apparatus 100A. The process shown in FIG. 13 begins when the power supply of the digital camera 200 is switched ON and the operating mode thereof is set in the image pickup mode. In the flowchart of FIG. 13, processing steps having identical content to the processing of the first embodiment, shown in the flowchart of FIG. 6, have been allocated identical step numbers to those of the flowchart in FIG. 6, and for the purpose of simplification, the following description focuses on differences with the first embodiment.

The flowchart of FIG. 13 differs from the first embodiment in that the processing (processing for recording the appearance frequency of each determination target region) of S604 in the flowchart of FIG. 6 has been replaced by processing of S1300, and the processing of S608 in the flowchart of FIG. 6 has been replaced by processing of S1302, S1304, and S1306.

During the image pickup preparation operation, the determination target regions are extracted in S602, and in S1300, the information enabling specification of the determination target regions is recorded together with information relating to the appearance frequency, brightness, saturation, and region properties of the determination target regions.

When the release operation by the user is detected subsequently in S606, the processing of S1302 is performed. In S1302, a determination is made as to whether or not the image pickup mode currently set in the digital camera 200 is the macro mode. When the determination is affirmative, the routine advances to S1304, and when the determination is negative, the routine advances to S1306. In S1304 to which the routine bifurcates when the set mode is determined to be the macro mode, a background region (a region corresponding to the part in which the background appears) is excluded from the importance determination targets, among the determination target regions extracted in S602, on the basis of the region property information recorded in S1300.

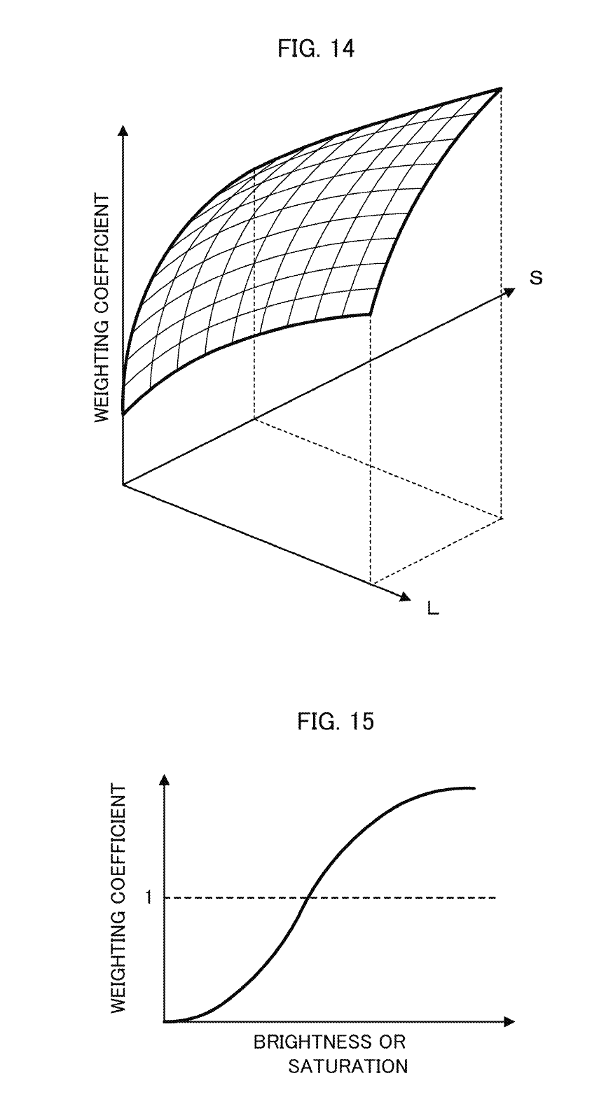

In S1306, processing is performed to derive the appearance frequency of each of the determination target regions extracted in S602 on the basis of the brightness and saturation information recorded in S1300 such that a steadily higher weighting is applied to the region as the brightness and saturation thereof increase. An example of a case in which a steadily higher weighting is applied as the brightness and saturation of the determination target region increase during derivation of the appearance frequency of the determination target region will now be described with reference to FIGS. 14 and 15.

FIG. 14 is a schematic graph showing an example of a weighting characteristic set in accordance with the brightness and saturation of a determination target region when deriving the appearance frequency of the determination target region. In the example shown in FIG. 14, a weighting coefficient is defined in accordance with a combination of the brightness (lightness) (L) and the saturation (S). The graph in FIG. 14 shows an example in which the weighting coefficient is increased as the brightness increases, the saturation increases, and the combination of the brightness and the saturation increases. In other words, according to this characteristic, when a plurality of determination target regions having identical appearance frequencies exist, the appearance frequency is counted higher as the brightness and saturation of the determination target region increase. This weighting characteristic may be defined in advance as a function having the brightness and the saturation as variables. Alternatively, the weighting characteristic shown in FIG. 14 may be set on a lookup table and stored in advance in the ROM 262.

FIG. 14 shows an example in which the weighting coefficient is increased as the brightness (lightness) and saturation increase, but as shown on a graph in FIG. 15, the weighting coefficient may be determined on the basis of the brightness (lightness) alone or on the basis of the saturation alone. In this case, the weighting coefficient may be set to increase as the saturation increases or as the brightness increases. The weighting characteristic shown in FIG. 15 may likewise be defined in advance as a function having the brightness or the saturation as a variable. Alternatively, the weighting characteristic shown in FIG. 15 may be set on a lookup table and stored in advance in the ROM 262.

Returning to the flowchart of FIG. 13, following the processing of S1306, the determination unit 106A performs the importance determination processing in S610. The processing of S612, S614, S616 and S618 is then performed on the basis of the importance determination results obtained in S610.

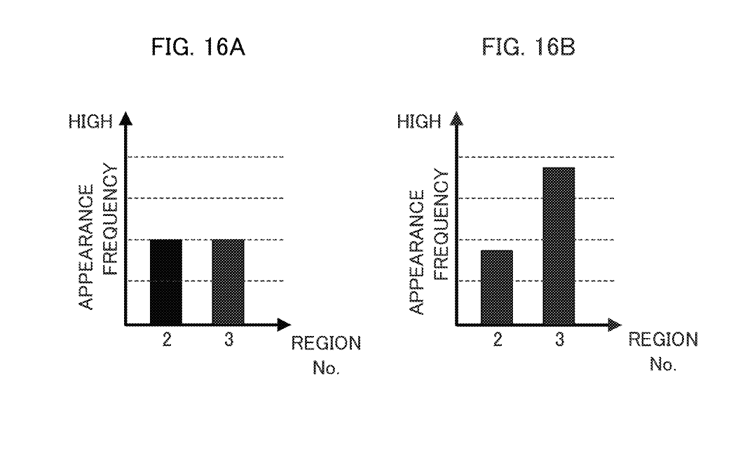

FIG. 16 is a view illustrating an example of a case in which the operating mode of the digital camera 200 is set in the macro mode and the importance of the region 2 and the region 3 is determined after eliminating the region 1 from the determination target regions as a result of the processing of S1304. In the graph shown in FIG. 16, the abscissa shows the region number of the determination target region and the ordinate shows the appearance frequency. FIG. 16A shows an example in which the appearance frequencies are derived without performing the weighting processing described above, while FIG. 16B shows an example in which the appearance frequencies are derived after performing the weighting processing described above.

In the example shown in FIG. 16, the brightness and saturation of the determination target region 3 are comparatively large, while the brightness and saturation of the determination target region 2 are comparatively small. Hence, the appearance frequency of the determination target region 2 shown in FIG. 16B is derived to be lower than the appearance frequency of the determination target region 2 prior to the weighting processing, shown in FIG. 16A. Further, the appearance frequency of the determination target region 3 shown in FIG. 16B is derived to be higher than the appearance frequency of the determination target region 3 prior to the weighting processing, shown in FIG. 16A. As a result, the importance of the determination target region 3 is determined to be great in S610, and therefore focus adjustment is performed on the flowers serving as the subject in the determination target region 3 (see FIG. 12).

According to the third embodiment, as described above, determination target regions are extracted from the series of multiple frames of the respective images input during the image pickup preparation operation, and the information enabling specification of the extracted determination target regions is recorded together with information enabling specification of the brightness and saturation of the determination target regions and the region property information of the determination target regions. Then, when the operating mode of the digital camera 200 is set in the macro mode, the determination target region including the background is excluded from the importance determination targets. In so doing, situations in which the appearance frequency of the determination target region including the background is higher than the appearance frequency of a determination target region that would normally be determined to have great importance when the composition has been set in order to photograph nearby flowers in an automatic focus adjustment macro mode, for example, with the result that the focus is automatically adjusted to the background by mistake, can be suppressed.

Further, the weighting is increased as the brightness and saturation increase, and therefore, in a situation where flowers are to be photographed in an automatic focus adjustment mode, for example, the probability that the focus will be adjusted to the flowers themselves (the petals) rather than the leaves can be increased. Moreover, when processing the image data, color reproduction processing, tone conversion processing, and so on can be performed with priority on the part determined to have great importance.

### Fourth Embodiment

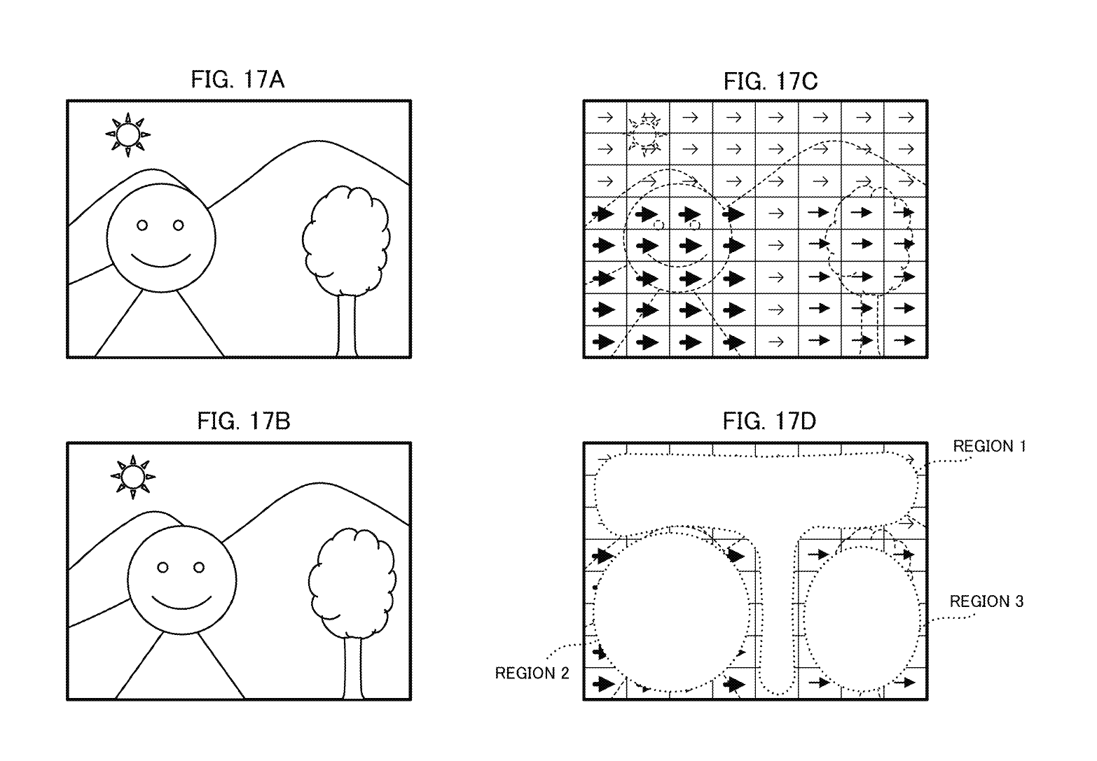

FIG. 17A is a view showing an example of an image generated by image pickup in the image pickup unit 220 of the digital camera 200 shown in FIG. 2 and input into the image input unit 102A. FIG. 17B is a view showing an example of an image input into the image input unit 102A after panning the digital camera 200 in a leftward direction from the viewpoint of a user holding the digital camera 200 from the rear. When a user pans a camera while holding the camera, a movement history of the panned camera typically includes a translational component as well as a rotational component if the movement of the camera is viewed from a viewpoint above the camera. This translational component movement is more likely to affect a nearby subject than a distant subject.

More specifically, when the camera is panned toward subjects positioned respectively at long, medium, and short distances, an image corresponding to the subject positioned at the short distance exhibits a greatest amount of movement over an image plane, followed respectively by images corresponding to the medium-distance and long-distance subjects.

In the example shown in FIG. 17B, an image of a person positioned at a short distance moves by the greatest amount, followed by an image of a tree positioned at a medium distance. Images corresponding to the sun and a row of mountains positioned at a long distance move by the smallest amount.

In the fourth embodiment, the determination target region extraction unit 104A analyzes the color and position of each pixel in the input image, and derives motion vectors. The determination target region extraction unit 104A then extracts the determination target regions on the basis of similarities among the motion vectors.

While repeatedly performing the processing for extracting the determination target regions from the series of multiple frames of the respective images input into the image input unit 102A, the color and position of each pixel in an image input first from among the images on the series of multiple frames, for example, are analyzed, and a plurality of motion vector detection regions are demarcated. Motion vectors are then derived by setting respective images in the plurality of demarcated motion vector detection regions as a template and performing processing to extract similar regions to those of the template from subsequently inputted images and derive a movement direction and a movement distance within the image.

In FIG. 17C, the image is divided by eight in the longitudinal and latitudinal directions to create 64 regions, and each one of these regions serves as a motion vector detection region. Arrows drawn in the respective motion vector detection regions schematically indicate the derived motion vectors. The determination target regions can be extracted from similarities between the motion vectors. FIG. 17C shows an example in which the motion vectors can be broadly divided into three types. As shown in FIG. 17D, three determination target regions (region 1, region 2, region 3) are extracted in accordance with these motion vector types.

Similarly to the first embodiment, the determination target region extraction processing performed by the determination target region extraction unit 104A may be performed on the frames of all of the images generated through successive image pickup by the image pickup unit 220, or on images obtained by performing skip readout at fixed or unfixed time intervals. When motion vectors are derived from images obtained through temporal skip readout in this manner, the motion vectors corresponding to the skipped frames (the frames not subjected to the determination region extraction processing) may be generated through interpolation.

When the template is determined during the motion vector derivation processing described above, the images in the entire demarcated motion vector detection regions may be used to form the template. However, by using regions near the center of gravity of the respective motion vector detection regions to form the template instead, a subsequent processing load can be reduced.

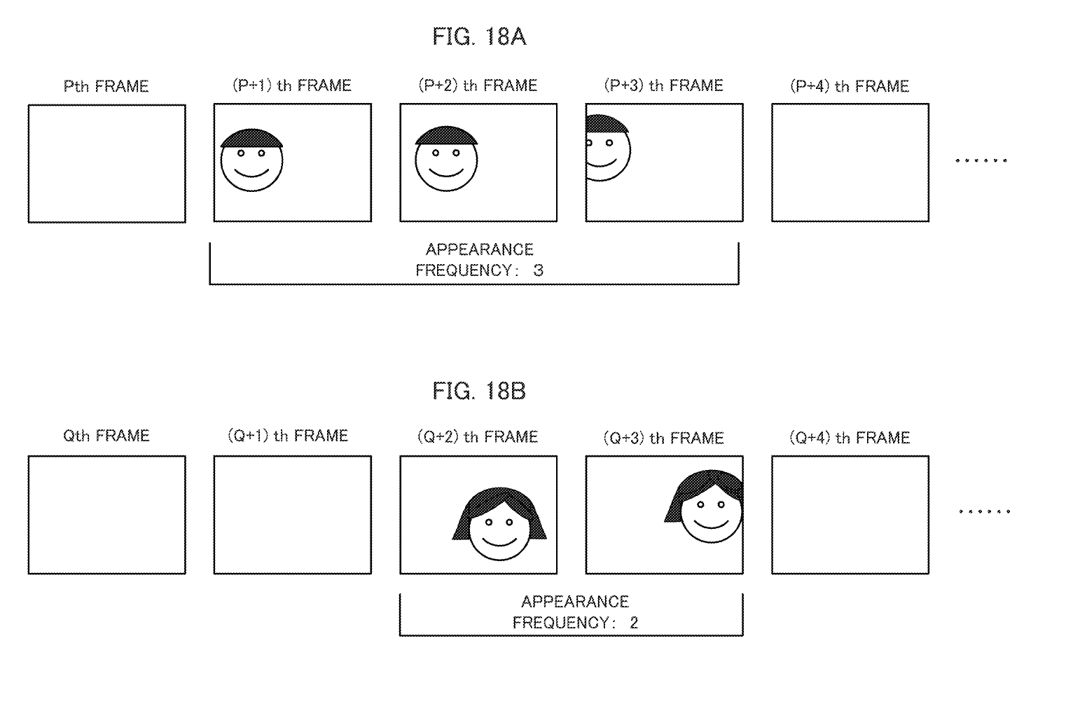

By having the determination target region extraction unit 104A perform the processing described above repeatedly before the release operation is performed on the digital camera 200, determination target regions are extracted successively in accordance with the respective frames input into the image input unit 102A. At this time, the determination target region extraction unit 104A counts the appearance frequency and a number of consecutive appearances for each extracted determination target region, and records information corresponding to the counting results together with the information enabling specification of the determination target regions. Referring to FIG. 18, which shows an example of images on a series of multiple frames input into the image input unit 102A, the number of consecutive appearances (the number of frames) is counted at three in the example shown in FIG. 18A and at two in the example shown in FIG. 18B.

Incidentally, while counting the number of consecutive appearances, a determination target region that exists near the edge of the screen or a determination target region corresponding to a subject that moves quickly, for example, may temporarily exit the frame such that recording of the consecutive appearances is interrupted. In this case, if a frame-exit period is within a predetermined period or a predetermined number of frames, the information may be recorded as if consecutive appearance were continuing. In other words, when the determination target region exits the frame temporarily, the number of appearances (the number of frames) continues to be counted during the frame-exit period as if the determination target region were still appearing consecutively. Alternatively, counting of the number of appearances may be stopped when the determination target region exits the frame, whereupon the number of appearances (number of frames) before the temporary frame-exit period is added to the number of appearances (number of frames) after the determination target region returns to the frame.

The number of consecutive appearances itself may be recorded as the information relating to the number of consecutive appearances, or information relating to a continuity of the appearances. More specifically, a ratio (N_cont/N_tot) between a total number of frames (indicated by N_tot) of the images input into the image input unit 102A during the release preparation operation and the number of consecutive appearances (number of appearing frames) (indicated by N_cont) may be used as the information relating to the continuity of the appearances.

When the release operation is subsequently detected, the determination unit 106A refers to the appearance frequency and the number of consecutive appearances of the respective determination target regions extracted and recorded by the determination target region extraction unit 104A, and derives the appearance frequency of each determination target region such that a steadily higher weighting is applied as the number of consecutive appearances increases. The determination unit 106A then compares the appearance frequencies derived for the respective determination target regions, and determines the importance of the determination target region to be greater as the appearance frequency increases.

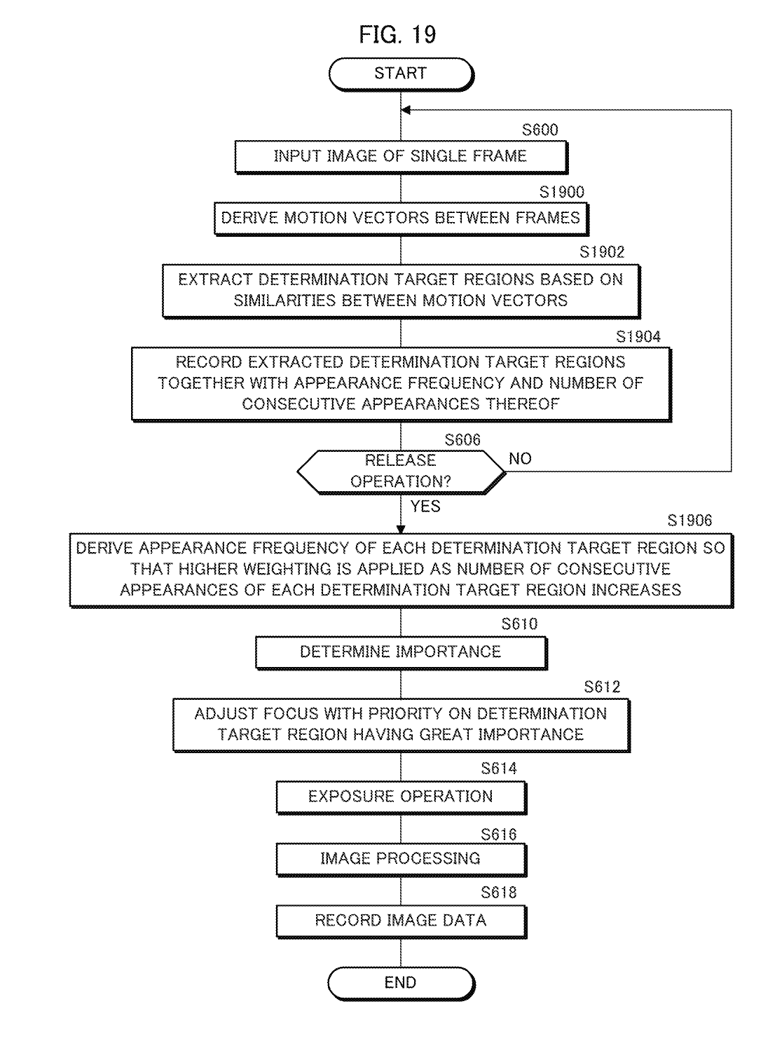

FIG. 19 is a flowchart illustrating an image pickup operation process executed by the CPU 270 of the digital camera 200 and the image processing apparatus 100A. The process shown in FIG. 19 begins when the power supply of the digital camera 200 is switched ON and the operating mode thereof is set in the image pickup mode. In the flowchart of FIG. 19, processing steps having identical content to the processing of the first embodiment, shown in the flowchart of FIG. 6, have been allocated identical step numbers to those of the flowchart in FIG. 6, and for the purpose of simplification, the following description focuses on differences with the first embodiment.

The flowchart of FIG. 19 differs from the first embodiment in that in the flowchart of FIG. 19, the processing (processing for extracting the determination target regions and processing for recording the appearance frequency of each determination target region) of S602 and S604 in the flowchart of FIG. 6 has been replaced by processing of S1900, S1902, and S1904, and the processing of S608 in the flowchart of FIG. 6 has been replaced by processing of S1906.

During the image pickup preparation operation, processing for deriving the motion vectors between the respective frames is performed in S1900, and processing for extracting the determination target regions on the basis of the similarities between the motion vectors is performed in S1902. Then, in S1904, information enabling specification of the determination target regions extracted in S1902 is recorded together with information relating to the appearance frequency and the number of consecutive appearances of the respective determination target regions.

When a release operation performed by the user is subsequently detected in S606, the processing of S1906 is performed. In S1906, the appearance frequency of each determination target region is derived such that a steadily higher weighting is applied as the number of consecutive appearances of each determination target region increases.

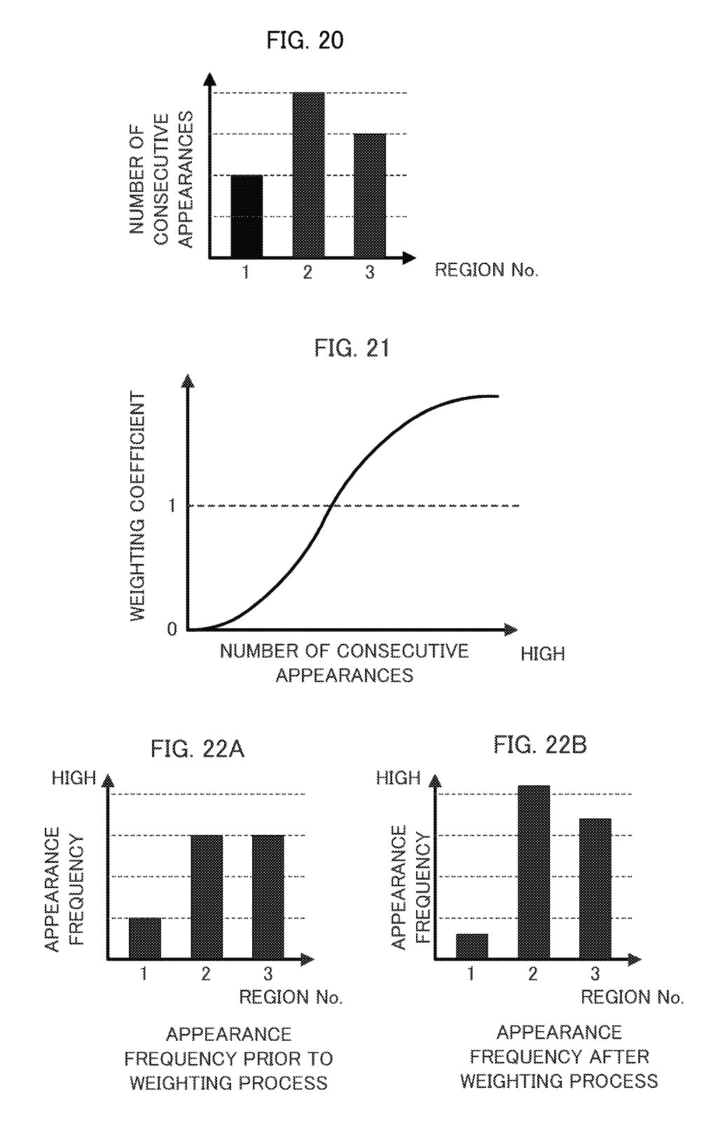

FIG. 20 is a graph showing a number of consecutive appearances recorded for the each region in the processing of S1904. On the graph, the abscissa shows the region number and the ordinate shows the number of consecutive appearances. FIG. 20 shows an example in which three determination target regions (region 1, region 2, region 3) are detected, and in which the region 2 has the highest number of consecutive appearances, followed in order by the region 3 and the region 1.

FIG. 21 is a schematic graph showing an example of a weighting characteristic set in accordance with the numbers of consecutive appearances of the respective determination target regions when deriving the appearance frequencies of the determination target regions. On the graph shown in FIG. 21, the abscissa shows the number of consecutive appearances and the ordinate shows the weighting coefficient. The graph has a characteristic whereby the weighting coefficient increases as the number of consecutive appearances increases. The weighting characteristic shown in FIG. 21 may be defined in advance as a function having the number of consecutive appearances as a variable. Alternatively, the weighting characteristic shown in FIG. 21 may be set on a lookup table and stored in advance in the ROM 262.

Returning to the flowchart of FIG. 19, following the processing of S1906, the determination unit 106A performs the importance determination processing in S610. The processing of S612, 5614, 5616 and 5618 is then performed on the basis of the importance determination results obtained in S610.

FIG. 22 is a view illustrating an example in which, as a result of the processing of S1906, weighting is applied to the respective appearance frequencies of the region 1, the region 2, and the region 3 in accordance with the respective numbers of consecutive appearances thereof. On the graph shown in FIG. 22, the abscissa shows the region numbers of the determination target regions and the ordinate shows the appearance frequency. FIG. 22A shows an example of appearance frequencies derived without performing the weighting processing described above, and FIG. 22B shows an example of appearance frequencies derived by performing the weighting processing described above.

As described above with reference to FIG. 20, the numbers of consecutive appearances of the respective determination target regions are set such that the region 2 has the highest number of consecutive appearances, followed in order by the region 3 and the region 1. The appearance frequency of the region 2 shown in FIG. 22B is weighted to be higher than the appearance frequency of the region 2 prior to the weighting processing, shown in FIG. 22A. On the other hand, the number of consecutive appearances of the region 3, which has an identical appearance frequency to the region 2 before the weighting processing, is smaller than the number of consecutive appearances of the region 2, and therefore the appearance frequency after the weighting processing is lower than the appearance frequency of the region 2. In the region 1 having a comparatively small number of consecutive appearances, the appearance frequency after the weighting processing is lower than the appearance frequency before the weighting processing. As a result, the importance of the determination target region 2 is determined to be great in S610. In S612, focus adjustment is performed with respect to a person serving as the subject corresponding to the determination target region 2 (see FIG. 17).

According to the fourth embodiment, as described above, motion vectors are derived from each of the images on the series of multiple frames input during the image pickup preparation operation, and the determination target regions are extracted on the basis of similarities between the motion vectors. Information enabling specification of the appearance frequency and the number of consecutive appearances of each determination target region is then recorded together with the information enabling specification of the extracted determination target regions. Further, prior to the importance determination, weighting is performed to increase the appearance frequency of the determination target region as the number of consecutive appearances increases.

The determination target regions are extracted from the images on the series of multiple frames input while the user holding the digital camera 200 adjusts the composition and waits for a photo opportunity, and the appearance frequency and number of consecutive appearances are counted for each determination target region. Assuming that the determination target regions include regions having identical or similar appearance frequencies (appearance frequencies prior to the weighting processing), these appearance frequencies are weighted in the processing of S1906 such that the appearance frequency increases as the number of consecutive appearances of the determination target region increases. Accordingly, in the importance determination of S610, a determination target region including a subject that is likely to be focused on by the user can be determined to be the main subject.

### Fifth Embodiment

In a fifth embodiment, an example in which the image generated through image pickup by the image pickup unit 220 of the digital camera shown in FIG. 2 and input into the image input unit 102A is likewise the image shown in FIG. 17 will be described.

In the fifth embodiment, the determination target region extraction unit 104A analyzes the color and position of each pixel in the input image and derives motion vectors. The determination target regions are then extracted on the basis of the similarities among the motion vectors.

When repeatedly performing the processing for extracting the determination target regions from the series of multiple frames of the respective images input into the image input unit 102A, similar processing to the processing of the fourth embodiment, described with reference to FIGS. 17C and 17D, is performed. More specifically, the color and position of each pixel in the image input first from among the images on the series of multiple frames, for example, are analyzed, and a plurality of motion vector detection regions are demarcated. Motion vectors are then derived by setting respective images in the plurality of demarcated motion vector detection regions as a template and performing processing to extract similar regions to those of the template from subsequently inputted images, and derive a movement direction and a movement distance within the image.

Similarly to the first embodiment, the determination target region extraction processing performed by the determination target region extraction unit 104A may be performed on the frames of all of the images generated through successive image pickup by the image pickup unit 220, or on images obtained by performing skip readout at fixed or unfixed time intervals. When motion vectors are derived from images obtained through temporal skip readout in this manner, the motion vectors corresponding to the skipped frames (the frames not subjected to the determination region extraction processing) may be generated through interpolation.

When the template is determined during the motion vector derivation processing described above, the images in the entire demarcated motion vector detection regions may be used to form the template. However, by using regions near the center of gravity of the respective motion vector detection regions to form the template instead, a subsequent processing load can be reduced.

By having the determination target region extraction unit 104A perform the processing described above repeatedly before the release operation is performed on the digital camera 200, determination target regions are extracted successively in accordance with the respective frames input into the image input unit 102A. At this time, the determination target region extraction unit 104A derives a degree of motionlessness of each extracted determination target region as well as counting the appearance frequency of each determination target region, and records information relating to the appearance frequency and the degree of motionlessness together with the information enabling specification of the determination target regions.

The degree of motionlessness will now be described. The degree of motionlessness may be defined as a smallness of movement by a subject (a determination target region) in an image. For example, in a situation where distant mountains are photographed with flowers swaying in the wind in the foreground using a camera mounted on a tripod or the like, the degree of motionlessness of the determination target region corresponding to the mountains is higher than the degree of motionlessness of the determination target region corresponding to a part including the flowers. Further, when the camera is held by hands and the orientation of the camera is changed continuously so that a child running around is kept in a fixed position of the screen at all times, the degree of motionlessness of the determination target region corresponding to the child is higher than the degree of motionlessness of the determination target region corresponding to the background. Hence, the degree of motionless is defined as being steadily higher as an amount of movement of the determination target region in the image decreases.

Referring to FIGS. 17C and 17D, the determination target region extraction unit 104A accumulates the motion vectors derived in accordance with the successively input frames along a temporal axis for each of the extracted determination target regions 1, 2, 3. The degree of motionlessness is then determined for each determination target region from the accumulated value of the motion vectors. At this time, the degree of motionlessness is derived so as to decrease as the accumulated value of the motion vectors increases. For example, in a case where the user pans the camera continuously such that the condition shown in FIG. 17C remains established, the determination target region corresponding to the region 1 (a subject positioned at a comparatively long distance appears in the region 1) in FIG. 17D has the highest degree of motionlessness and the determination target region corresponding to the region 2 (a subject positioned at a comparatively short distance appears in the region 2) has the lowest degree of motionlessness.

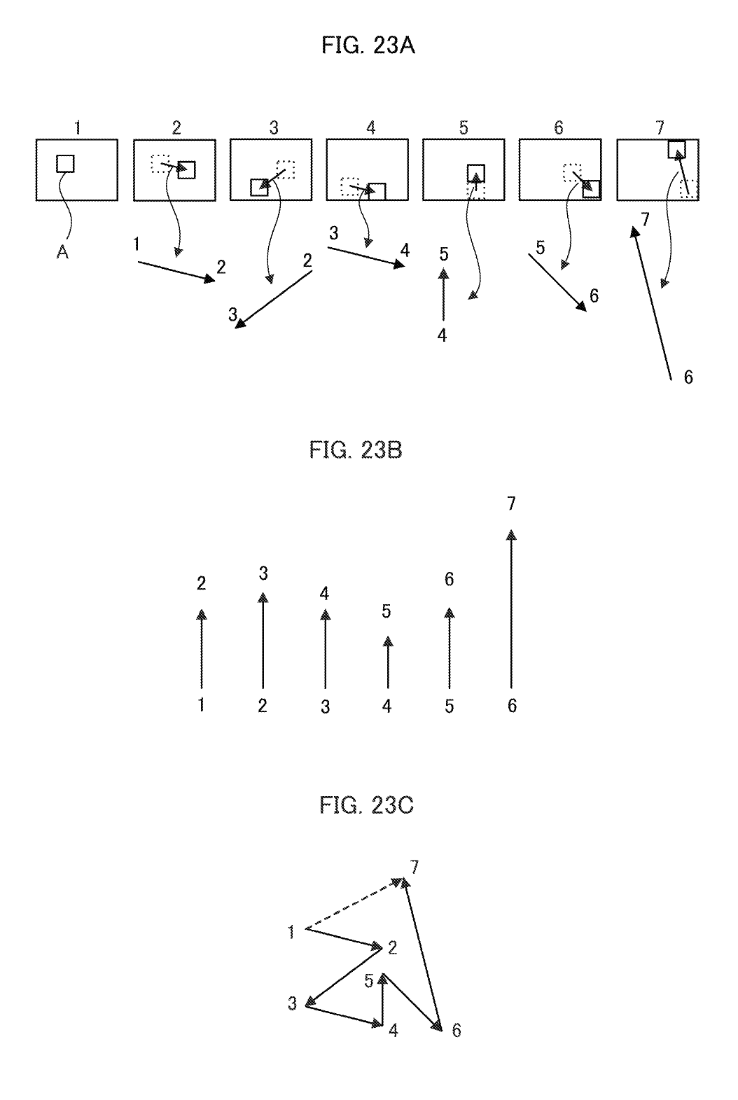

When accumulating the motion vectors derived in accordance with the images of the plurality of successively input frames along a temporal axis for each of the extracted determination target regions 1, 2, 3, directions of the motion vectors may be ignored such that only absolute values thereof are accumulated. This will now be described with reference to FIG. 23. FIG. 23A is a schematic view showing an example of motion vectors derived between respective frames when the movement of a certain determination target region A on the screen is followed from an image of a first frame to an image of a seventh frame. Numerals in FIG. 23 denote frame numbers. More specifically, a vector having 1 as a start point and 2 as an end point indicates a motion vector of the determination target region A derived between the image of the first frame and the image of the following second frame. Hereafter, the vectors shown in FIG. 23 will be referred to as a motion vector 1-2, a motion vector 2-3, and so on. In other words, a motion vector derived between the image of an nth frame and the image of a following mth frame will be expressed as a vector n-m.

FIG. 23B is a schematic view showing an example in which directions of the motion vectors are ignored and only absolute values are accumulated along a temporal axis. In other words, the degree of motionlessness is derived on the basis of a result obtained by removing direction information and accumulating absolute values of the motion vector 1-2, the motion vector 2-3, . . . , the motion vector 6-7. It should be noted that when the absolute values of the motion vectors are accumulated in this manner, the accumulated value of the motion vectors determined in accordance with a determination target region having a high appearance frequency (having a long appearance time) may increase, depending on the image pickup conditions. To deal with such cases, the degree of motionlessness may be derived on the basis of a value obtained by dividing the accumulated value of the motion vectors derived for each determination target region along a temporal axis by the appearance frequency, appearance time, and so on of the corresponding determination target region. Alternatively, a function, a lookup table, an algorithm, or the like may be prepared, and the degree of motionlessness may be derived from the accumulated value of the motion vectors and an appearance frame numbers or the appearance time of the corresponding determination target region.

Alternatively, instead of the method of ignoring the motion vector directions and accumulating only the absolute values, as described above, the motion vectors may be accumulated along a temporal axis taking into consideration both the directions and the absolute values such that the degree of motionlessness is derived on the basis of a finally obtained motion vector. FIG. 23C is a schematic view showing an example of this method. When the motion vector 1-2, the motion vector 2-3, . . . , the motion vector 6-7 are accumulated along a temporal axis taking into consideration both the directions and the absolute values thereof, a motion vector 1-7 indicated by a dashed line in FIG. 23C is derived finally.

The finally derived motion vector obtained by accumulating the motion vectors derived from the respective frames along a temporal axis in the manner described above will be referred to hereafter as a resultant motion vector. When deriving the degree of motionlessness, the degree of motionlessness may be set to decrease as the magnitude of the absolute value of the resultant motion vector 1-7 increases. At this time, the degree of motionlessness may be derived also taking into consideration the orientation of the resultant motion vector. For example, orientations of respective resultant motion vectors corresponding to the extracted determination target regions may be determined, and the orientations of the resultant motion vectors may be processed statistically. An average value or a standard deviation may be determined as a simple method of processing the resultant motion vectors statistically. The degree of motionlessness may then be determined using a criterion derived from a degree to which the orientation of the resultant motion vector of a certain determination target region deviates from the average value of a whole image. The degree of motionlessness may be determined to be lower as the deviation from the average value increases. At this time, the degree of motionlessness may be derived also taking into consideration the absolute value of the resultant motion vector. More specifically, the degree of motionlessness may be derived to be smaller as the orientation of the resultant motion vector deviates from the average value and as the absolute value of the resultant motion vector increases.

In the example described above, motion vectors are derived from the input images on the series of multiple frames. However, a pixel movement amount may be derived instead. More specifically, assuming that pixels are arranged on a two-dimensional X-Y plane, a number of pixels in an X axis direction and a number of pixels in a Y direction by which a predetermined determination target region moves between two images may be determined, and the degree of motionlessness may be determined on the basis of the magnitude of these values.

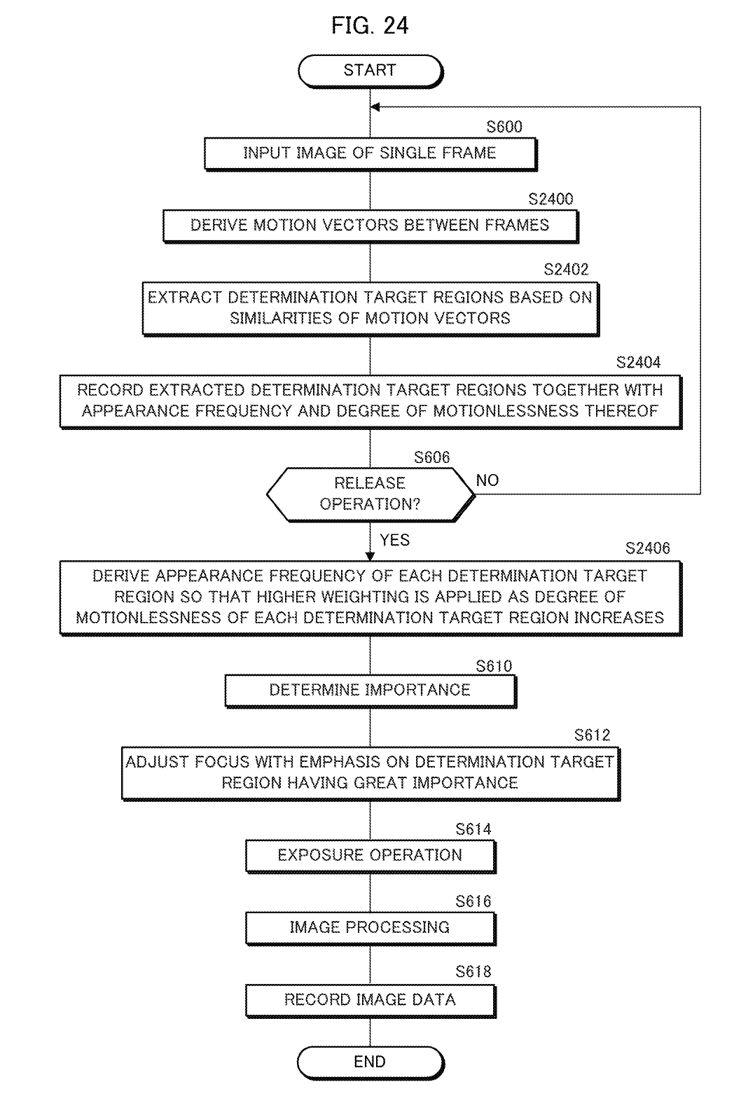

FIG. 24 is a flowchart illustrating an image pickup operation process executed by the CPU 270 of the digital camera 200 and the image processing apparatus 100A. The process shown in FIG. 24 begins when the power supply of the digital camera 200 is switched ON and the operating mode thereof is set in the image pickup mode. In the flowchart of FIG. 24, processing steps having identical content to the processing of the first embodiment, shown in the flowchart of FIG. 6, have been allocated identical step numbers to those of the flowchart in FIG. 6, and for the purpose of simplification, the following description focuses on differences with the first embodiment.

The flowchart of FIG. 24 differs from the first embodiment in that in the flowchart of FIG. 24, the processing (processing for extracting the determination target regions and processing for recording the appearance frequency of each determination target region) of S602 and S604 in the flowchart of FIG. 6 has been replaced by processing of S2400, S2402, and S2404, and the processing of S608 in the flowchart of FIG. 6 has been replaced by processing of S2406.

During the image pickup preparation operation, processing for deriving the motion vectors between the respective frames is performed in S2400, and processing for extracting the determination target regions on the basis of the similarities between the motion vectors is performed in S2402. Then, in S2404, information enabling specification of the determination target regions extracted in S2402 is recorded together with information relating to the appearance frequency and the degree of motionlessness of the respective determination target regions. The degree of motionlessness and the derivation method thereof are as described above.

When a release operation performed by the user is subsequently detected in S606, the processing of S2406 is performed. In S2406, the appearance frequency of each determination target region is derived such that a steadily higher weighting is applied as the degree of motionlessness of each determination target region increases.

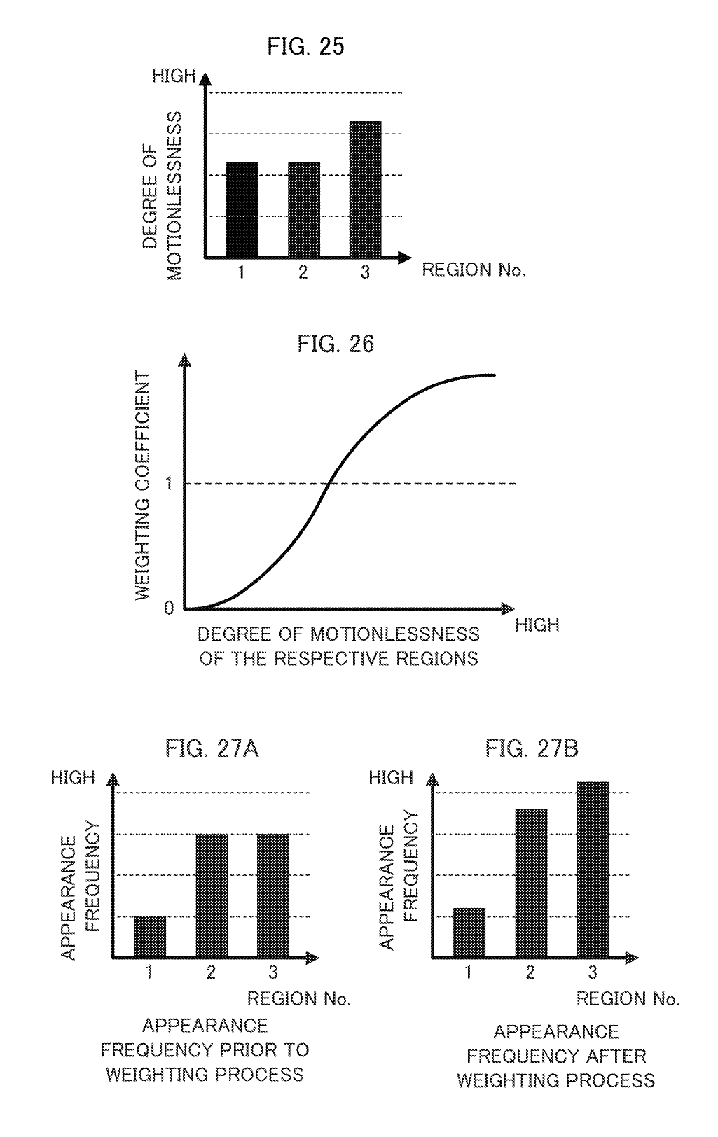

FIG. 25 is a graph showing the degree of motionlessness for each region, derived and recorded in the processing of S2404. On the graph, the abscissa shows the region number of each determination target region and the ordinate shows the degree of motionlessness. FIG. 25 shows an example in which three determination target regions (region 1, region 2, region 3) are detected, wherein the region 3 has the highest degree of motionlessness while the region 1 and the region 2 have a substantially identical degree of motionlessness which is lower than that of the region 3.

FIG. 26 is a schematic graph showing an example of a weighting characteristic set in accordance with the degrees of motionlessness of the respective determination target regions when deriving the appearance frequencies of the determination target regions. On the graph shown in FIG. 26, the abscissa shows the degree of motionlessness and the ordinate shows the weighting coefficient. The graph has a characteristic whereby the weighting coefficient increases as the degree of motionlessness increases. The weighting characteristic shown in FIG. 26 may be defined in advance as a function having the degree of motionlessness as a variable. Alternatively, the weighting characteristic shown in FIG. 26 may be set on a lookup table and stored in advance in the ROM 262.

Returning to the flowchart of FIG. 24, following the processing of S2406, the determination unit 106A performs the importance determination processing in S610. The processing of S612, S614, S616 and S618 is then performed on the basis of the importance determination results obtained in S610.

FIG. 27 is a view illustrating an example in which, as a result of the processing of S2406, weighting is applied to the appearance frequencies of the region 1, the region 2, and the region 3 in accordance with the respective degrees of motionlessness thereof. On the graph shown in FIG. 27, the abscissa shows the region numbers of the determination target regions and the ordinate shows the appearance frequency. FIG. 27A shows an example of appearance frequencies derived without performing the weighting processing described above, and FIG. 27B shows an example of appearance frequencies derived by performing the weighting processing described above.

As described above with reference to FIG. 25, the degrees of motionlessness of the respective determination target regions are set such that the region 3 has a higher degree of motionlessness than the regions 1 and 2 while the regions 1 and 2 have substantially identical degrees of motionlessness. Hence, the appearance frequency of the region 3 shown in FIG. 27B is weighted to be higher than the appearance frequency of the region 3 prior to the weighting processing, shown in FIG. 27A. On the other hand, the degree of motionlessness of the region 1 and the region 2 is also comparatively high, and therefore the appearance frequencies of the region 1 and the region 2 shown in FIG. 27B are weighted to be higher than the appearance frequencies thereof shown in FIG. 27A. However, the degree of motionlessness of the region 1 and the region 2 is lower than the degree of motionlessness of the region 3, and therefore, as shown in FIG. 27B, the appearance frequency of the region 2 is not increased as far as the appearance frequency of the region 3. As a result, the region 3 has the highest appearance frequency following the weighting processing.

The importance of the determination target region 3 is determined to be great in S610. In S612, focus adjustment is performed with respect to the subject corresponding to the determination target region 3.

According to the fifth embodiment, as described above, motion vectors are derived from each of the images on the series of multiple frames input during the image pickup preparation operation, and the determination target regions are extracted on the basis of similarities between the motion vectors. The degree of motionlessness is then derived for each of the extracted determination target regions. Information enabling specification of the appearance frequency and the degree of motionlessness of each determination target region is then recorded together with the information enabling specification of the extracted determination target regions. Further, prior to the importance determination, weighting is performed to increase the appearance frequency of the determination target region as the degree of motionlessness increases.

The determination target regions are extracted from each of the images on the series of multiple frames input while the user holding the digital camera 200 adjusts the composition and waits for a photo opportunity, and the appearance frequency is counted for each determination target region. Further, the degree of motionlessness is derived for each determination target region. Assuming that the determination target regions include regions having identical or similar appearance frequencies (appearance frequencies prior to the weighting processing), these appearance frequencies are weighted in the processing of S2406 such that the appearance frequency increases as the degree of motionlessness of the determination target region increases. Accordingly, in the importance determination of S610, a determination target region including a subject that is likely to be focused on by the user can be determined to be the main subject region.

In the example described in the fifth embodiment, weighting is performed such that when a plurality of determination target regions have identical appearance frequencies, the appearance frequency derived in relation to the appearance of a determination target region having a high degree of motionlessness, or in other words a determination target region exhibiting little positional variation within the image, is increased. However, processing may also be performed to count and record the number of consecutive appearances of each determination target region using the method described in the fourth embodiment. The weighting may then be performed such that when a plurality of determination target regions have identical appearance frequencies, the appearance frequency derived in relation to the appearance of a determination target region exhibiting little positional variation within the image (a high degree of motionlessness) and having a larger number of consecutive appearances is increased.

As a method for performing the weighting described above, weighting coefficients may be derived in accordance with a combination of the degree of motionlessness and the number of consecutive appearances by replacing the brightness (lightness) (L) and the saturation (S) with the degree of motionlessness and the number of consecutive appearances, respectively, on the graph shown in FIG. 14 and described in the third embodiment, on which the weighting coefficient is defined in accordance with a combination of the brightness (lightness) (L) and the saturation (S), for example. This weighting characteristic may be defined in advance as a function having the degree of motionlessness and the number of consecutive appearances as variables. Alternatively, the characteristic shown in FIG. 10 may be set on a lookup table and stored in advance in the ROM 262.

In the first embodiment to the fifth embodiment described above, examples in which this invention is applied to the digital camera 200 were described. As noted initially, however, the processing described in the first to fifth embodiments may be performed using a dedicated image processing apparatus capable of inputting and processing a series of multiple frames of images captured in temporal sequence. Further, the image processing apparatus described above may be realized by executing an image processing program using a general-purpose computer.

The image processing technique according to this invention may be applied to a digital still camera, a digital movie camera, and so on, and may also be applied to a video recorder, a computer, and so on. Embodiments of this invention described above, but the above embodiments merely illustrate examples of application of this invention, and the technical scope of this invention is not limited to the specific constitutions of the embodiments. This invention may be subjected to various amendments and modifications within a scope that does not depart from the spirit thereof.

Additional advantages and modifications will readily occur to those skilled in the art. Therefore, the invention in its broader aspects is not limited to the specific details and representative devices shown and described herein. Accordingly, various modifications may be made without departing from the spirit or scope of the general inventive concept as defined by the appended claims and their equivalents.

This application claims priority on the basis of JP2010-196636, filed with the Japan Patent Office on Sep. 2, 2010, the entire contents of which are incorporated into this specification by reference.

What is claimed is:

1. An image processing apparatus that determines an importance of a subject in an image, comprising:
an image input unit that inputs a series of multiple frames of images captured in temporal sequence;
a determination target region extraction unit that extracts determination target regions to be subjected to an importance determination from the images on the multiple frames input into the image input unit; and
a determination unit that determines the importance of the determination target regions on the basis of an appearance frequency of the determination target regions in the images on the multiple frames.

2. The image processing apparatus as defined in claim 1, wherein the determination unit is further constituted to refer to an appearance history of the determination target regions in the images on the multiple frames, derive the appearance frequency such that when the determination target regions have identical appearance frequencies, an appearance frequency derived in relation to a more recent appearance is set to be higher than an appearance frequency derived in relation to a less recent appearance, and determine that the importance of the determination target region having the higher appearance frequency is great.

3. The image processing apparatus as defined in claim 1, wherein the determination unit is further constituted to specify a determination target region corresponding to a part in which a background appears from the determination target regions extracted by the determination target region extraction unit, and exclude the determination target region corresponding to the part in which the background appears from the determination target regions subjected to the importance determination.

4. The image processing apparatus as defined in claim 1, wherein the determination unit is further constituted to refer to at least one of a brightness and a saturation of the determination target regions in the images on the plurality of frames, derive the appearance frequency such that when the determination target regions have identical appearance frequencies, the appearance frequency is derived to be higher in relation to appearances of a determination target region in which at least one of the brightness and the saturation is higher, and determine that the importance of the determination target region having the higher appearance frequency is great.

5. The image processing apparatus as defined in claim 1, wherein the determination unit is further constituted to refer to a number of consecutive appearances, which is a number of consecutive appearances of the determination target region in the images on the plurality of frames, derive the appearance frequency such that when the determination target regions have identical appearance frequencies, the appearance frequency is derived to be higher in relation to appearances of a determination target region having a higher number of consecutive appearances, and determine that the importance of the determination target region having the higher appearance frequency is great.

6. The image processing apparatus as defined in claim 1, wherein the determination unit is further constituted to refer to a positional variation in the determination target region in the images, derive the appearance frequency such that when the determination target regions have identical appearance frequencies, the appearance frequency is derived to be higher in relation to appearances of a determination target region exhibiting less positional variation, and determine that the importance of the determination target region having the higher appearance frequency is great.

7. The image processing apparatus as defined in claim 6, wherein the determination unit is further constituted to refer to a number of consecutive appearances, which is a number of consecutive appearances of the determination target region in the images on the plurality of frames, derive the appearance frequency such that when the determination target regions have identical appearance frequencies, the appearance frequency is derived to be higher in relation to appearances of a determination target region exhibiting less positional variation and having a higher number of consecutive appearances, and determine that the importance of the determination target region having the higher appearance frequency is great.

8. An image processing method for determining an importance of a subject in an image, comprising:
an image inputting step for inputting a series of multiple frames of images captured in temporal sequence;
a determination target region extracting step for extracting determination target regions to be subjected to an importance determination from the images on the multiple frames input in the image inputting step; and
a determining step for determining the importance of the determination target regions on the basis of an appearance frequency of the determination target regions in the images on the multiple frames.

9. An image pickup apparatus having an imaging unit capable of subjecting an object image formed by an image pickup lens to photoelectric conversion and outputting a corresponding image signal, comprising:
an image input unit that inputs a series of multiple frames of images captured in temporal sequence;
a determination target region extraction unit that extracts determination target regions to be subjected to an importance determination from the images on the multiple frames input into the image input unit; and
a determination unit that determines an importance of the determination target regions on the basis of an appearance frequency of the determination target regions in the images on the multiple frames.

10. A non-transitory computer-readable storage medium storing an image processing program for causing a computer to execute processing for determining an importance of a subject in an image, comprising:
an image inputting step for inputting a series of multiple frames of images captured in temporal sequence;
a determination target region extracting step for extracting determination target regions to be subjected to an importance determination from the images on the multiple frames input in the image inputting step; and
a determining step for determining the importance of the determination target regions on the basis of an appearance frequency of the determination target regions in the images on the multiple frames.
